(19) United States
(12) Patent Application Publication
(10) Pub. No.: US 2010/0013795 A1
(43) Pub. Date: Jan. 21, 2010

(54) Display apparatus, method for controlling display apparatus, and electronic apparatus

(75) Inventor: Kazunori Okino, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/459,842

(22) Filed: Jul. 7, 2009

(30) Foreign Application Priority Data
Jul. 8, 2008 (JP) JP 2008-178144

(51) Int. Cl. G06F 3/042

(52) U.S. Cl. 345/175

(57) ABSTRACT

A display apparatus includes a display unit including display elements and light detection elements, a light emitting unit including a light emitting element, a first controller for controlling the light emitting element, a second controller for selectively controlling the light detection elements, a signal processing unit for processing a detection signal obtained by detecting light emitted from the light emitting unit using the light detection elements and acquiring coordinate information, and a clock generator for providing a base frequency to the signal processing unit and the first and second controllers. The first controller causes the light emitting element to emit light during a signal light emission period and stop emission of the light during a light emission stop period, and the first controller superposes the base frequency on a signal serving as the coordinate information and causes the light emitting element to emit light during the signal light emission period.

### CROSS-REFERENCE TO RELATED APPLICATION

The present application claims priority from Japanese Patent Application JP 2008-178144 filed in the Japanese Patent Office on Jul. 8, 2008, the entire content of which is incorporated herein by reference.

### BACKGROUND OF THE INVENTION

1. Field of the Invention

present invention relates to a display apparatus including a photosensor element, a method for controlling the display apparatus, and an electronic apparatus.

2. Description of the Related Art

In recent years, flat display apparatuses including photosensor elements in a display element area have been developed (refer to, for example, Japanese Unexamined Patent Application Publication Nos. 2004-318819, 2004-45785, 7-325319, 2002-268615, and 2007-304451 and Japanese Patent No. 4055722).

These flat display apparatuses include pixels arranged in a matrix. Each of the pixels includes a thin-film transistor (TFT) functioning as a display element and a photoelectric transducer element. Thus, the display apparatuses can display an image and receive information using light made incident on the photoelectric transducer element.

When liquid crystal display elements are used as the display elements, transmission of light through the liquid crystal display elements is used in order to display an image. Accordingly, the display apparatus includes backlight or frontlight serving as a light source.

The display apparatus having such a configuration can display an image and receive information using the same screen area. Accordingly, the display apparatus can be used as an information input/output device that replaces, for example, a touch panel.

For example, some display apparatuses of cell phones, digital cameras, and video cameras are composed of a combination of a liquid crystal display device and a touch panel.

For the display apparatuses, a user looks at an image displayed on the liquid crystal display device and operates the display apparatuses. Since the touch panel is disposed immediately above the display device, the user can directly manipulate the image via the touch panel.

However, since the user looks at the image through the touch panel, the image quality, such as the resolution and luminance of the image, is degraded.

In addition, in, in particular, small mobile devices, the thickness and weight are important factors affecting the portability of the devices. Accordingly, the display apparatus having the above-described configuration allows the user to directly operate a displayed image. In addition, the thickness and weight of the mobile device can be reduced without decreasing the image quality.

As shown in FIGS. 1A and 1B, in the display apparatuses having the above-described configuration, when a user moves their finger over the image display screen in the vicinity of a desired position, the photoelectric transducer element disposed so as to correspond to the position detects light reflected by the finger.

By using such a configuration, input of information performed by a user is facilitated.

However, in such a case, it is necessary that the detection result of the photoelectric transducer element is not influenced by the intensity of the external light in order to increase the accuracy of the input information and the sensitivity.

### SUMMARY OF THE INVENTION

When obtaining the coordinate information from the intensity distribution through image processing as described in Japanese Unexamined Patent Application Publication Nos. 2004-318819, 2004-45785, 7-325319, 2002-268615, and 2007-304451 and Japanese Patent No. 4055722, incorrect coordinate information may be obtained due to the external light, as described above.

For example, as described in Japanese Unexamined Patent Application Publication No. 2007-304451, the luminance information excluding influence of external light can be obtained by using the difference between the luminance values of the reflected light when the backlight is turned on and off.

However, in this configuration, it is difficult to obtain a satisfactory detection result when black is displayed. In addition, in order to acquire the coordinate information from the luminance distribution, highly complicated image processing is necessary.

In addition, in order to detect light emitted from the unit itself, a technique for modulating the light is widely used. In the case of liquid crystal display devices, backlight may perform a modulating operation. In the case of light-emitting elements (e.g., organic ELs), the light-emitting elements may perform a modulating operation. However, in such cases, the quality of an image may be decreased. In addition, although this technique is effective under natural light, it may be difficult to detect coordinate information under the light emitted from an inverter light source.

Accordingly, the present invention provides a display apparatus, a method for controlling the display apparatus, and an electronic apparatus capable of preventing incorrect detection due to external light, reducing an adverse effect of the external light on the quality of an image, and precisely detecting approach of an object to a display screen or touch of the object on the display screen.

According to an embodiment of the present invention, a display apparatus includes a display unit including a plurality of display elements and light detection elements, a light emitting unit including a light emitting element that emits light in order to acquire coordinate information, a first control unit configured to control the light emitting element of the light emitting unit, a second control unit configured to selectively control driving of the plurality of light detection elements, a signal processing unit configured to process a detection signal obtained by detecting light emitted from the light emitting unit using the light detection elements and acquire the coordinate information, and a clock generation unit configured to provide a base frequency to the signal processing unit and the first and second control units. The first control unit causes the light emitting element of the light emitting unit to emit light during a signal light emission period and stop emission of the light during a light emission stop period, and the first control unit superposes the base frequency on a signal serving as the coordinate information and causes the light emitting element of the light emitting unit to emit light during the signal light emission period.

The base frequency can be a frequency other than a frequency generated by inverter lighting equipment.

The coordinate information can be generated so as to exclude a bit pattern in which all the bits are “0”s or all the bits are “1”s.

The second control unit can select one of the light detection elements in synchronization with the coordinate information contained in a signal emitted from the light emitting element of the light emitting unit.

The signal processing unit can extract a component having the base frequency from the detection signal and acquire the coordinate information by removing the component having the base frequency from the detection signal.

The second control unit can select one of the light detection elements by providing a gap period so that the signals output from the light detection elements are not superposed.

The second control unit can generate the coordinate information using a cycle more than or equal to twice a sum of one cycle of the base frequency and the gap period.

The light detection elements can be disposed in a black matrix portion of the display unit, and the coordinate information can be generated so as to indicate that detected reflection light is light from the black matrix portion when the reflection light from the black matrix portion is detected.

The light emitting unit used for acquiring the coordinate information can include a light emitting element for direct illumination, and the first control unit that controls the light emitting element of the light emitting unit can cause the light emitting element to emit light at the base frequency, and the second control unit that selectively controls driving of the plurality of light detection elements can select one of the light detection elements to be driven in synchronization with the coordinate information contained in a signal emitted from the light emitting element during a signal detection period, stop the emission of light from the light emitting element during a light emission stop period, and operate in synchronization with a signal serving as the coordinate information.

The display apparatus can further include a backlight that emits display light onto the display unit. The display unit can use a plurality of basic frequencies and include a plurality of signal processing units each corresponding to one of the basic frequencies, and the display apparatus can determine whether received light is reflection light from the backlight or transmission light from the light emitting element for direct illumination and operate in accordance with the determined type of the light.

The display apparatus can have a control function capable of stopping the operation of the light emitting unit used for acquiring the coordinate information when the operation of the light emitting unit used for acquiring the coordinate information is not necessary.

According to another embodiment of the present invention, a method for driving a display apparatus is provided. The display apparatus includes a display unit including a plurality of display elements and light detection elements and a light emitting unit including a light emitting element for acquiring coordinate information. The display apparatus processes a detection signal obtained by using the light detection elements and detecting light emitted from the light emitting unit so as to acquire the coordinate information. The method includes the step of causing the light emitting element of the light emitting unit to emit light during a signal light emission period and stop emission of the light during a light emission stop period. During the signal light emission period, the base frequency is superposed on a signal serving as the coordinate information, and the light emitting unit emits the light.

According to still another embodiment of the present invention, an electronic apparatus includes a display apparatus. The display apparatus includes a display unit including a plurality of display elements and light detection elements, a light emitting unit including a light emitting element that emits light in order to acquire coordinate information, a first control unit configured to control the light emitting element of the light emitting unit, a second control unit configured to selectively control driving of the plurality of light detection elements, a signal processing unit configured to process a detection signal obtained by detecting light emitted from the light emitting unit using the light detection elements and acquire the coordinate information, and a clock generation unit configured to provide a base frequency to the signal processing unit and the first and second control units. The first control unit causes the light emitting element of the light emitting unit to emit light during a signal light emission period and stop emission of the light during a light emission stop period, and the first control unit superposes the base frequency on a signal serving as the coordinate information and causes the light emitting element of the light emitting unit to emit light during the signal light emission period.

According to the embodiments of the present invention, the first control unit causes the light emitting element of the light emitting unit to emit light during a signal light emission period and stop emission of the light during a light emission stop period, and, during the signal light emission period, the first control unit superposes the base frequency on a signal serving as the coordinate information and causes the light emitting element of the light emitting unit to emit the light. Subsequently, the signal processing unit processes a detection signal obtained by using the light detection elements that detect light emitted from the light emitting unit so as to acquire the coordinate information.

According to the embodiments of the present invention, incorrect detection of the coordinate information due to influence of external light can be prevented. Approach of an object towards a display screen or touch of the object on the display screen can be accurately detected without performing complicated image processing and without degrading the quality of an image.

### BRIEF DESCRIPTION OF THE DRAWINGS

FIGS. 1A and 1B illustrate a detecting operation performed by a display apparatus including photosensor elements in a display element area;

FIG. 2 is a block diagram of an image display apparatus according to a first exemplary embodiment of the present invention;

FIG. 3 is a first diagram illustrating an exemplary configuration of the image display apparatus according to the first exemplary embodiment;

FIG. 4 is a second diagram illustrating the exemplary configuration of the image display apparatus according to the first exemplary embodiment;

FIG. 5 illustrates exemplary configurations of a light detection pixel drive control unit and a light emission control unit according to the first exemplary embodiment;

FIG. 6 illustrates exemplary configurations of an X-axis light detection pixel drive unit and a Y-axis light detection pixel drive unit;

FIG. 7 illustrates an exemplary configuration of a light emitting unit according to the first exemplary embodiment;

FIG. 8 illustrates an exemplary configuration of a clock generation unit according to the first exemplary embodiment;

FIG. 9 is a timing diagram of the clock generation unit shown in FIG. 8;

FIG. 10 illustrates an exemplary configuration of a signal processing unit according to the first exemplary embodiment;

FIG. 11 is a timing diagram of when the light emission control unit generates a signal LED_Sig;

FIG. 12 is a timing diagram of when the light emission control unit generates a signal LED_En;

FIG. 13 illustrates the case in which a finger touches four of light detection pixels of an image display unit;

FIG. 14 is a timing diagram of the X-axis light detection pixel drive unit for the 0th bit of the X value;

FIG. 15 illustrates an optical system of a flat display apparatus according to the first exemplary embodiment;

FIG. 16 is a timing diagram of when a touch signal is output from the signal processing unit;

FIG. 17 illustrates an image display apparatus according to a second exemplary embodiment of the present invention;

FIG. 18 is a diagram illustrating an example of a touch signal detected in the second exemplary embodiment;

FIG. 19 illustrates a pattern of a value included in a light emission signal LED_Sig and a value output as a touch signal;

FIG. 20 illustrates a particular example of a value included in a light emission signal LED_Sig and a value output as a touch signal;

FIG. 21 illustrates exemplary configurations of an X-axis light detection pixel drive unit and a Y-axis light detection pixel drive unit of an image display apparatus according to a third exemplary embodiment of the present invention;

FIG. 22 illustrates an exemplary configuration of a light emitting unit according to the third exemplary embodiment;

FIG. 23 is a timing diagram of when light is emitted from the light pen onto an area in place of being touched by a finger;

FIG. 24 illustrates an exemplary configuration of a light emitting unit according to a fourth exemplary embodiment of the present invention;

FIG. 25 is a diagram illustrating an exemplary configuration of a clock generation unit that generates a clock used by the light emitting unit according to the fourth exemplary embodiment;

FIG. 26 illustrates an exemplary configuration of a signal processing unit according to the fourth exemplary embodiment;

FIG. 27 is a block diagram illustrating an exemplary configuration of a digital camera according to a fifth exemplary embodiment of the present invention;

FIG. 28 is a perspective view of a television set to which one of the embodiments above is applied;

FIGS. 29A and 29B are perspective views of a digital camera to which one of the embodiments above is applied;

FIG. 30 is a perspective view of a laptop personal computer to which one of the exemplary embodiments above is applied;

FIG. 31 is a perspective view of a video camera to which one of the exemplary embodiments above is applied; and

FIGS. 32A to 32G are diagrams illustrating a mobile terminal device (e.g., a cell phone) to which one of the exemplary embodiments above is applied.

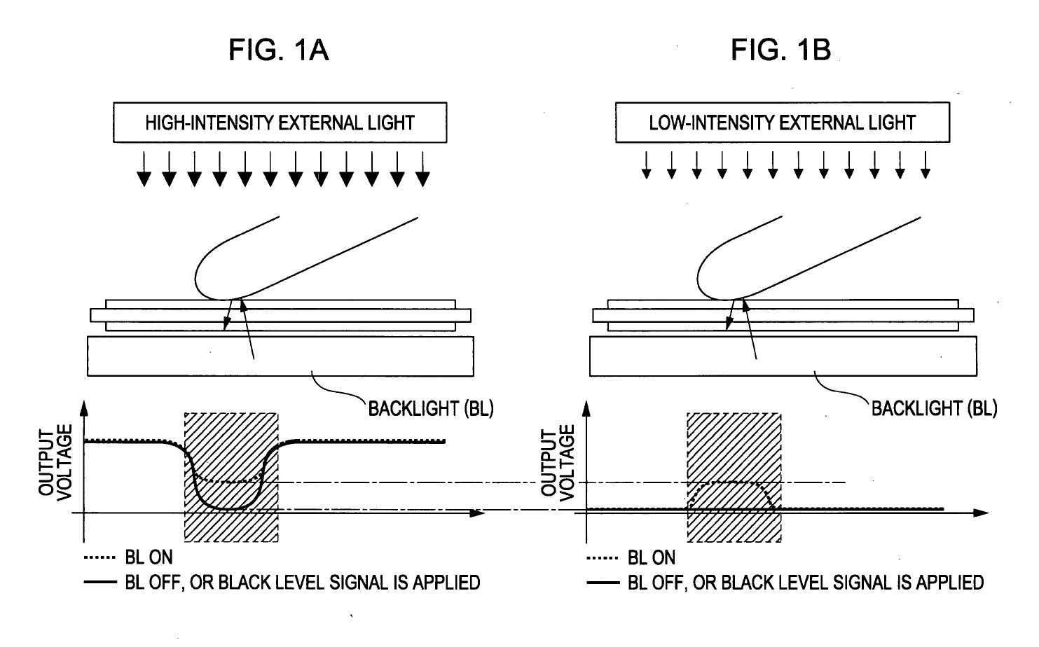

### DESCRIPTION OF THE PREFERRED EMBODIMENTS

Various exemplary embodiments of the present invention are described below with reference to the accompanying drawings.

### First Exemplary Embodiment

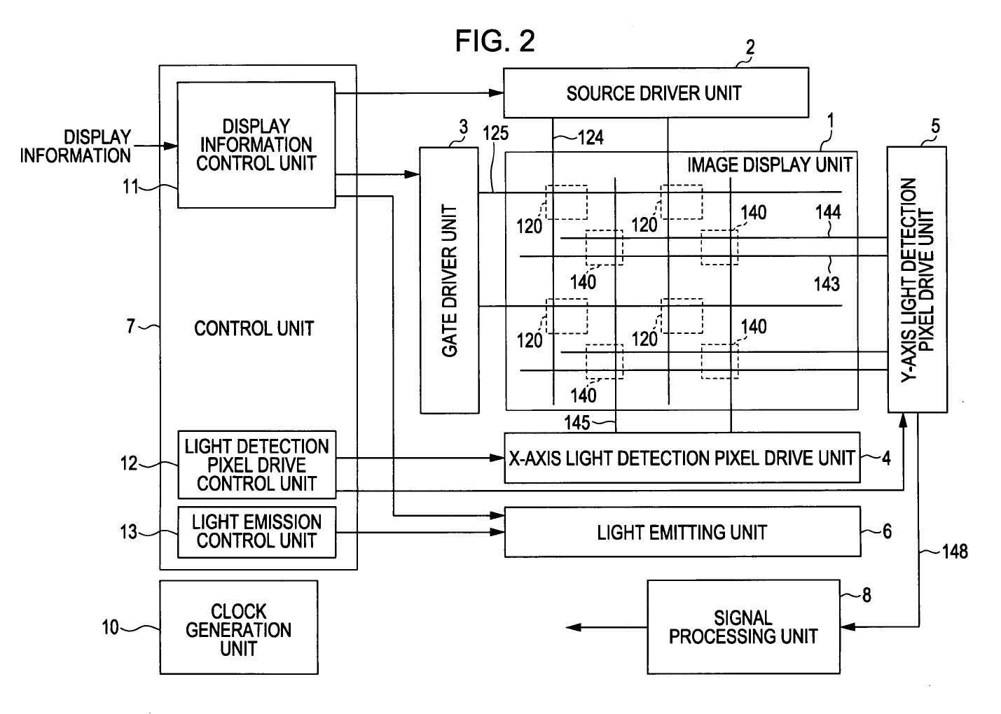

FIG. 2 is a block diagram of an exemplary configuration of an image display apparatus according to a first exemplary embodiment of the present invention.

An image display apparatus D includes an image display unit 1, a source driver unit 2, a gate driver unit 3, an X-axis light detection pixel drive unit 4, a Y-axis light detection pixel drive unit 5, a light emitting unit 6, a control unit 7, a signal processing unit 8, and a clock generation unit 10.

The image display unit 1 includes display pixels 120 and light detection pixels 140 arranged in a matrix.

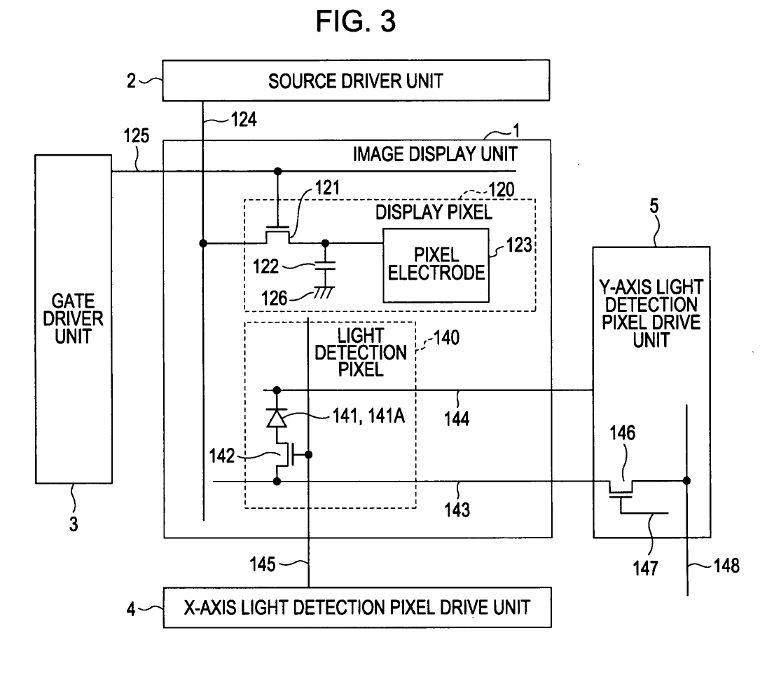

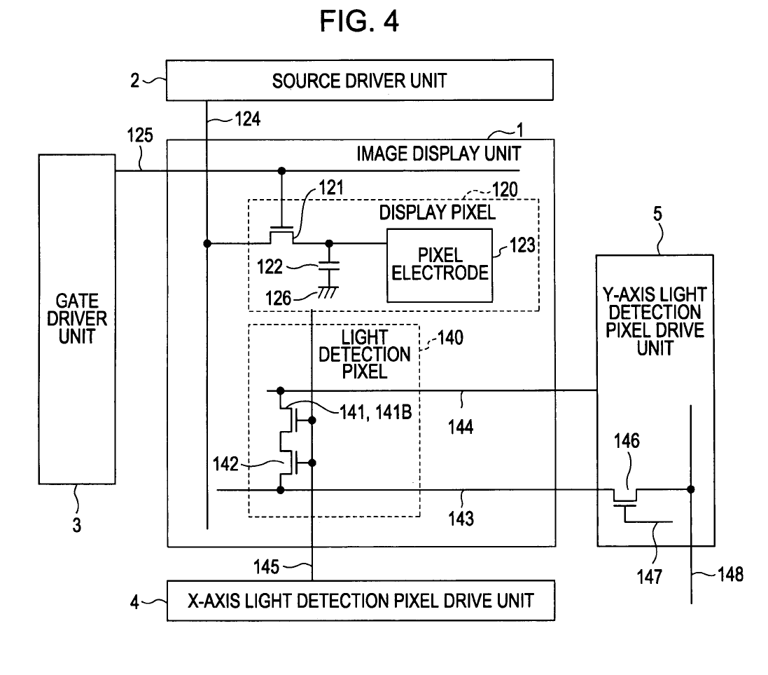

FIGS. 3 and 4 illustrate exemplary configurations of the image display unit 1 according to the present embodiment. The configurations shown in FIGS. 3 and 4 are basically the same. However, the types of light detection elements are different.

### Structure of Display Pixel 120

As shown in FIGS. 3 and 4, each of the display pixels 120 includes a thin-film transistor (TFT) 121, an auxiliary capacitor 122, and a pixel electrode 123. The display pixel 120 further includes a liquid crystal layer disposed between the pixel electrode 123 formed at one end of the TFT 121 and a counter electrode. The display pixels 120 are formed at intersections between source signal lines 124 vertically arranged in parallel and gate signal lines 125 horizontally arranged in parallel or in the vicinities of the intersections.

One electrode of the auxiliary capacitor 122 is connected to the drain of the TFT 121 and the pixel electrode 123, while the other electrode is connected to a common signal line 126.

### Structure of Light Detection Pixel 140

As shown in FIGS. 3 and 4, each of the light detection pixels 140 includes a light detecting element 141 and an X-axis output selecting transistor 142.

For example, as shown in FIG. 3, a photodiode 141A is used as the light detecting element 141. Alternatively, as shown in FIG. 4, a phototransistor 141B is used as the light detecting element 141.

The X-axis output selecting transistor 142 selectively outputs, to a light detection pixel X-axis output signal line 143, the output of the light detecting element 141. One end of the light detecting element 141 is connected to a light detection pixel power supply line 144.

FIG. 3 illustrates the image display unit 1 in which the photodiode 141A is used as the light detecting element 141, while FIG. 4 illustrates the image display unit 1 in which the phototransistor 141B is used as the light detecting element 141.

For each of the display pixels 120, one of the source signal lines 124 and one of the gate signal lines 125 are connected to the display pixel 120. The source signal line 124 is connected to the source of the TFT 121. One end of the source signal line 124 is connected to the source driver unit 2 that drives the source. The gate signal line 125 is connected to the gate of the TFT 121. One end of the gate signal line 125 is connected to the gate driver unit 3 that drives the gate.

The light detection pixel X-axis output signal line 143 and the light detection pixel power supply line 144 are wired to each of the light detection pixels 140 in the horizontal direction. An X-axis light detection pixel control line 145 is wired to each of the light detection pixels 140 in the vertical direction. One end of the light detection pixel X-axis output signal line 143 and one end of the light detection pixel power supply line 144 are connected to the Y-axis light detection pixel drive unit 5. The X-axis light detection pixel control line 145 is connected to the gate of the X-axis output selecting transistor 142. One end of the X-axis light detection pixel control line 145 is connected to the X-axis light detection pixel drive unit 4.

### Arrangement of Light Detection Pixels 140

The light detection pixels 140 are not necessarily arranged so as to correspond to the display pixels 120 in a one-to-one correspondence, but may be independently arranged regardless of the number of display pixels.

As described in more detail in a second exemplary embodiment, the light detection pixels 140 may be disposed under a black mask disposed outside the display pixel area.

In addition, the display pixels 120 are not limited to liquid crystal elements, but may be light-emitting elements, such as electro-luminescence (EL) elements.

The source driver unit 2 has a capability of digital-to-analog (D/A) converting input digital pixel data into an analog voltage suitable for driving the display element. Alternatively, the source driver unit 2 may have a capability to output a digital signal used for performing pulse width modulation (PWM). In such a case, the source driver unit 2 has a configuration in which digital data are applied to the source signal lines 124 in the form of pulse signals. Accordingly, the necessity of the D/A conversion circuit can be eliminated.

The gate driver unit 3 sequentially selects one of the gate signal lines 125 and writes image data into the display pixel 120 in synchronization with the source driver unit 2.

Under the control of the control unit 7, the X-axis light detection pixel drive unit 4 drives the X-axis light detection pixel control line 145 so as to read the detection result of the light detecting element 141 of the light detection pixel 140 into the light detection pixel X-axis output signal line 143.

As shown in FIGS. 3 and 4, the Y-axis light detection pixel drive unit 5 incorporates a Y-axis output selecting transistor 146.

One end of the Y-axis output selecting transistor 146 is connected to the light detection pixel. X-axis output signal line 143, while the other end is connected to a light detection pixel output signal line 148. The gate of the Y-axis output selecting transistor 146 is connected to a Y-axis light detection pixel control line 147.

Under the control of the control unit 7, the Y-axis light detection pixel drive unit 5 supplies the detection result of the light detecting element 141 read into the light detection pixel X-axis output signal line 143 to the signal processing unit 8 via the light detection pixel output signal line 148.

Under the control of the control unit 7, the light emitting unit 6 causes a light-emitting element to emit light during a signal light emitting period and to stop emitting the light during a signal light non-emitting period. During the signal light emitting period, a base frequency is superposed on the signal, and the light is emitted. Note that the base frequency is, for example, a frequency other than the frequency that is generated by inverter lighting equipment.

The control unit 7 controls the source driver unit 2 and the gate driver unit 3 so as to drive the display pixels 120. In addition, the control unit 7 controls the X-axis light detection pixel drive unit 4 and the Y-axis light detection pixel drive unit 5 so as to drive the light detection pixels 140. Furthermore, the control unit 7 controls light emission from the light emitting unit 6.

The signal processing unit 8 receives the output of the Y-axis light detection pixel drive unit 5 and outputs a signal processing result in the form of an output signal. Note that, in the present embodiment, the signal represents coordinate information. A signal having a bit pattern of all bits of “0”s or “1”s is not used for the coordinate information.

The clock generation unit 10 supplies a clock SysClk 1020 and a clock 4SysClk 1040 to each block.

A power supply unit (not shown) supplies drive power to each of the blocks.

Exemplary configurations and functions of the control unit 7, the X-axis light detection pixel drive unit 4, the Y-axis light detection pixel drive unit 5, the light emitting unit 6, the clock generation unit 10, and the signal processing unit 8 are described first and, subsequently, predetermined operations are described.

As shown in FIG. 2, the control unit 7 includes a display information control unit 11, a light detection pixel drive control unit 12 serving as a second control unit, and a light emission control unit 13 serving as a first control unit.

The display information control unit 11 of the control unit 7 controls the source driver unit 2 and the gate driver unit 3 using pixel data lines and control signal lines. The light detection pixel drive control unit 12 of the control unit 7 controls the X-axis light detection pixel drive unit 4 and the Y-axis light detection pixel drive unit 5. The light emission control unit 13 of the control unit 7 controls the light emitting unit 6 that emits light.

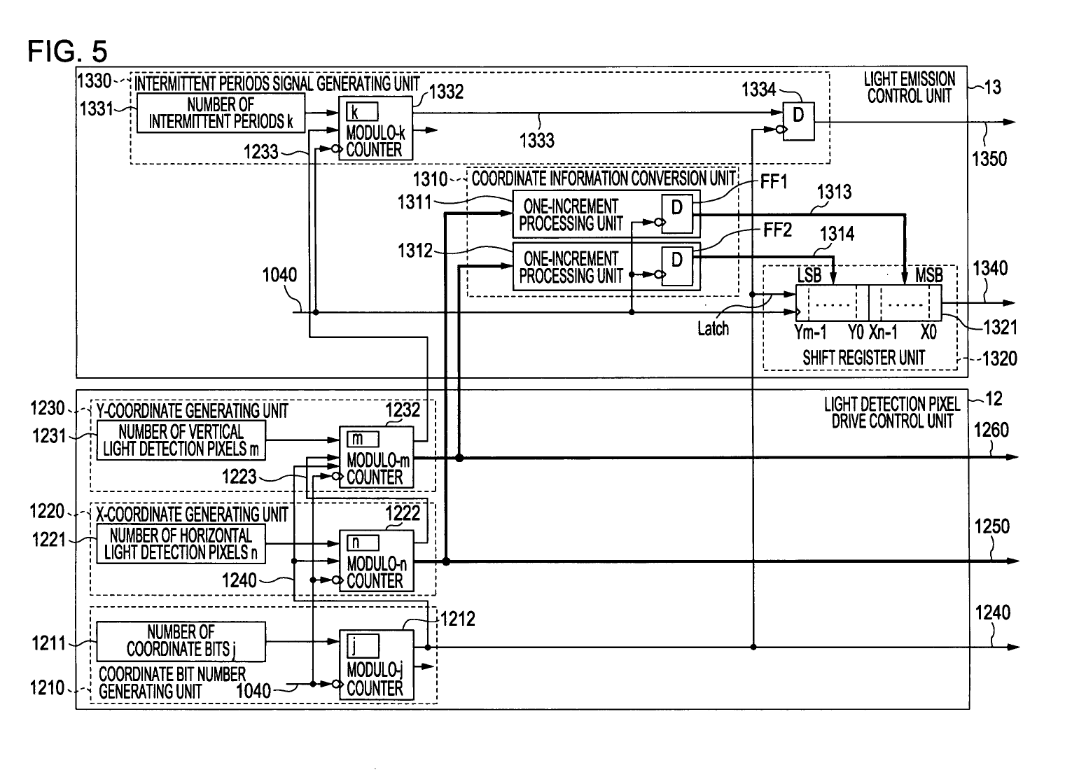

FIG. 5 illustrates exemplary configurations of the light detection pixel drive control unit 12 and the light emission control unit 13 of the control unit 7 according to the present embodiment.

As shown in FIG. 5, the light detection pixel drive control unit 12 includes a coordinate bit number generating unit 1210, an X-coordinate generating unit 1220, and a Y-coordinate generating unit 1230.

The coordinate bit number generating unit 1210 includes a coordinate bit number register 1211 that determines the number of bits for one pixel and a modulo-j counter 1212 that counts up to j when the determined number of bits is j.

The coordinate bit number register 1211 is composed of a microcomputer (not shown) or switches. The clock 4SysClk 1040 generated by the clock generation unit 10 is supplied to a clock terminal of the modulo-j counter 1212. The modulo-j counter 1212 counts the input of the clock 4SysClk 1040 and outputs a carrier signal bCa 1240 to the X-axis light detection pixel drive unit 4 and the Y-axis light detection pixel drive unit 5.

The X-coordinate generating unit 1220 includes a horizontal light detection pixel register 1221 that determines the number of horizontal light detection pixels and a modulo-n counter 1222 that counts up to n when the determined number of horizontal light detection pixels is n. The horizontal light detection pixel register 1221 is composed of a microcomputer (not shown) or switches.

The clock 4SysClk 1040 generated by the clock generation unit 10 is supplied to the modulo-n counter 1222, which counts the input of a carrier signal bCa 1240 from the modulo-j counter 1212. The modulo-n counter 1222 outputs X-axis coordinate information 1250 and a carrier signal 1223 serving as count information. The modulo-n counter 1222 outputs the X-axis coordinate information 1250 to the X-axis light detection pixel drive unit 4.

The Y-coordinate generating unit 1230 includes a vertical light detection pixel register 1231 that determines the number of vertical light detection pixels and a modulo-m counter 1232 that counts up to m when the determined number of vertical light detection pixels is m.

The vertical light detection pixel register 1231 is composed of a microcomputer (not shown) or switches (not shown).

The clock 4SysClk 1040 generated by the clock generation unit 10 is supplied to the modulo-m counter 1232, which counts the carrier signal 1223 input from the modulo-n counter 1222. The modulo-m counter 1232 outputs Y-axis coordinate information 1260 and a carrier signal 1233 serving as count information. The modulo-m counter 1232 outputs the Y-axis coordinate information 1260 to the Y-axis light detection pixel drive unit 5.

The carrier signal 1233 is generated from the carrier signal bCa 1240 and the carrier signal 1223 of the modulo-n counter 1222.

While a method for generating the information has been described with reference to counters, the method is not limited thereto. For example, the information may be generated using a microcomputer.

As shown in FIG. 5, the light emission control unit 13 includes a coordinate information conversion unit 1310, a shift register unit 1320, and an intermittent signal generating unit 1330.

The coordinate information conversion unit 1310 includes one-increment processing units 1311 and 1312. The one-increment processing unit 1311 incorporates a D flip-flop FF1. The one-increment processing unit 1311 receives the X-axis coordinate information 1250 generated by the light detection pixel drive control unit 12 and increments the X-axis coordinate information 1250 by one. The one-increment processing unit 1311 holds the value incremented by one in synchronization with the clock 4SysClk 1040. The one-increment processing unit 1311 then outputs the held value to the shift register unit 1320 as an X value 1313.

The one-increment processing unit 1312 incorporates a D flip-flop FF2. The one-increment processing unit 1312 receives the Y-axis coordinate information 1260 generated by the light detection pixel drive control unit 12 and increments the Y-axis coordinate information 1260 by one. The one-increment processing unit 1312 holds the value incremented by one in synchronization with the clock 4SysClk 1040. The one-increment processing unit 1312 then outputs the held value to the shift register unit 1320 as a Y value 1314.

However, a method for generating the X value 1313 and the Y value 1314 is not limited to the above-described one-increment method. For example, a conversion method using a lookup table may be employed. In addition, a microcomputer may generate the X value 1313 and the Y value 1314.

Any value other than that when all the bits are “0” or “1” may be used. When all the bits are “0”, a case is indicated in which coordinate information is not detected, and when all the bits are “1”, the value generated by inverter lighting equipment is indicated.

The shift register unit 1320 includes a shift register 1321. The shift register 1321 has the number of bits obtained by summing the number of horizontal light detection pixels n and the number of vertical light detection pixels m.

The shift register 1321 receives the carrier signal bCa 1240 generated by the light detection pixel drive control unit 12. The carrier signal bCa 1240 serves as an input latch signal. The shift register 1321 retrieves and latches the X value 1313 and the Y value 1314 in synchronization with the input latch signal. The shift register 1321 uses the clock 4SysClk 1040 output from the clock generation unit 10 in order to output the latched data. Thus, the shift register 1321 outputs a signal LED_Sig 1340.

When the data is retrieved, any arrangement of bits of the data is allowed if the arrangement is associated with touch signal output from the signal processing unit 8 in advance. In FIG. 5, the X value 1313 is placed in the least significant bits, and the Y value 1314 is placed in the most significant bits. The bits are sequentially output from the first bit of the X value 1313.

The intermittent signal generating unit 1330 includes an intermittent number register 1331 that determines the number of intermittent periods, a modulo-k counter 1332 that counts up to k when the number of intermittent periods is k, and a D flip-flop 1334 that defines the output timing of the shift register 1321 as the output timing of the intermittent signal generating unit 1330.

The intermittent number register 1331 is composed of a microcomputer (not shown) or switches (not shown).

The clock 4SysClk 1040 generated by the clock generation unit 10 is supplied to a clock terminal of the modulo-k counter 1332. The modulo-k counter 1332 counts the input of the carrier signal 1233 received from the modulo-m counter 1232 of the light detection pixel drive control unit 12 and outputs a carrier signal 1333.

In order to operate in synchronization with the shift register 1321, the D flip-flop 1334 receives the carrier signal bCa 1240 as a clock signal. The D flip-flop 1334 further receives the carrier signal 1333 output from the modulo-k counter 1332 so as to output a signal LED_En 1350 to the light emitting unit 6.

The signal LED_En 1350 is used for reducing consumption power of a light-emitting element unit 630 when light is detected. Accordingly, the method for generating the signal LED_En 1350 has been described with reference to a counter. However, the present embodiment is not limited to a method in which a counter is used. Any other method using, for example, a microcomputer may be employed.

In addition, while the above-described embodiment has been described with reference to a method in which the operation is performed once for every k times, the operation may be performed a plurality of times for every k times.

### Configuration of Light Detection Pixel Drive Unit

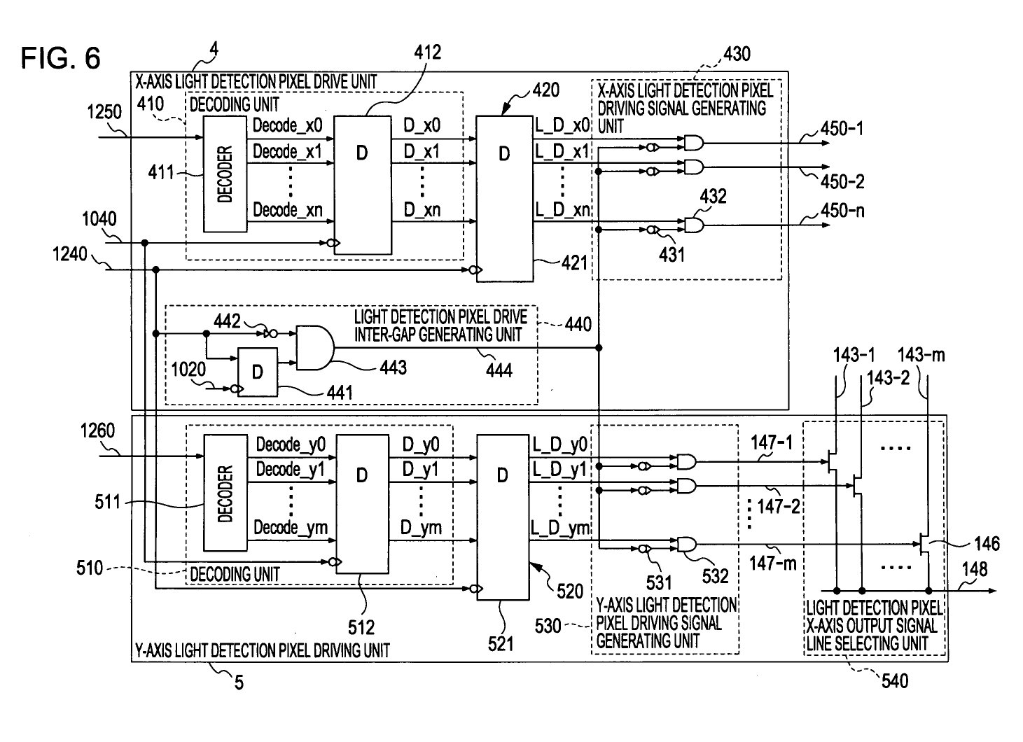

FIG. 6 illustrates exemplary configurations of the X-axis light detection pixel drive unit 4 and the Y-axis light detection pixel drive unit 5 according to the present embodiment.

As shown in FIG. 6, the X-axis light detection pixel drive unit 4 includes a decoding unit 410, a latch unit 420, an X-axis light detection pixel driving signal generating unit 430, and a light detection pixel drive inter-gap generating unit 440.

The decoding unit 410 includes a decoder 411 and a D flip-flop unit 412.

The decoder 411 receives the X-axis coordinate information 1250 of the light detection pixel drive control unit 12 as an input signal. The decoder 411 then outputs, to the D flip-flop unit 412, decoding results Decode_x0 to Decode_xn.

The D flip-flop unit 412 includes n D flip-flops. Each of the D flip-flops receives the clock 4SysClk 1040 output from the clock generation unit 10 as a clock input. In addition, each of the D flip-flops outputs, to the latch unit 420, a corresponding one of the outputs Decode_x0 to Decode_xn of the decoder 411 as a corresponding one of output signals D_x0 and D_xn in synchronization with the clock 4SysClk 1040.

The latch unit 420 includes a D flip-flop unit 421. The D flip-flop unit 421 includes n D flip-flops. In order to operate in synchronization with the shift register 1321 of the light emission control unit 13, each of the D flip-flops receives the carrier signal bCa 1240 of the light detection pixel drive control unit 12 as a clock input. In addition, each of the D flip-flops receives a corresponding one of the outputs D_x0 to D_xn of the D flip-flop unit 412 and outputs, to the X-axis light detection pixel driving signal generating unit 430, a corresponding one of signals L_D_x0 to L_D_xn in synchronization with the carrier signal bCa 1240.

The X-axis light detection pixel driving signal generating unit 430 includes a plurality of NOT elements 431 and a plurality of AND elements 432. One of the NOT elements 431 and one of the AND elements 432 form a pair so that n pairs are formed.

The NOT elements 431 receive a gap signal 444 output from the light detection pixel drive inter-gap generating unit 440 as an input signal. The output of each of the NOT elements 431 is connected to one of the two inputs of the corresponding one of the AND elements 432. The other input of the AND element 432 receives the corresponding one of the signals L_D_x0 to L_D_xn output from the D flip-flop unit 421. Outputs of the n AND elements 432 are output to n X-axis light detection pixel control lines 450-1 to 450-n.

The light detection pixel drive inter-gap generating unit 440 includes a D flip-flop 441, a NOT element 442, and an AND element 443.

The D flip-flop 441 receives the clock SysClk 1020 output from the clock generation unit 10 as an input synchronization clock signal. In addition, the D flip-flop 441 receives the carrier signal bCa 1240 output from the light detection pixel drive control unit 12. The output of the D flip-flop 441 is connected to one of the inputs of the AND element 443.

The NOT element 442 receives the carrier signal bCa 1240 as an input signal. The output of the NOT element 442 is connected to the other input of the AND element 443.

The AND element 443 performs a logical AND operation on the output of the D flip-flop 441 and the output of the NOT element 442 so as to generate the gap signal 444. The AND element 443 then supplies the generated gap signal 444 to the plurality of NOT elements 431 of the X-axis light detection pixel driving signal generating unit 430. In addition, the gap signal 444 is supplied to the Y-axis light detection pixel drive unit 5.

As shown in FIG. 6, the Y-axis light detection pixel drive unit 5 includes a decoding unit 510, a latch unit 520, the Y-axis light detection pixel driving signal generating unit 530, and a light detection pixel X-axis output signal line selecting unit 540.

The decoding unit 510 includes a decoder 511 and a D flip-flop unit 512.

The decoder 511 receives the Y-axis coordinate information 1260 of the light detection pixel drive control unit 12 as an input signal. The decoder 511 then outputs, to the D flip-flop unit 512, decoding results Decode_y0 to Decode_ym.

The D flip-flop unit 512 includes m D flip-flops. Each of the D flip-flops receives the clock 4SysClk 1040 output from the clock generation unit 10 as an input clock signal. In addition, each of the D flip-flops outputs, to the latch unit 520, a corresponding one of the outputs Decode_y0 to Decode_ym of the decoder 511 as a corresponding one of signals D_y0 to D_ym in synchronization with the clock 4SysClk 1040.

The latch unit 520 includes a D flip-flop unit 521. The D flip-flop unit 521 includes n D flip-flops. In order to operate in synchronization with the shift register 1321 of the light emission control unit 13, each of the D flip-flops receives the carrier signal bCa 1240 of the light detection pixel drive control unit 12 as an input clock signal. In addition, each of the D flip-flops receives a corresponding one of the outputs D_y0 to D_ym of the D flip-flop unit 512 and outputs, to the Y-axis light detection pixel driving signal generating unit 530, a corresponding one of signals L_D_y0 to L_D_ym in synchronization with the carrier signal bCa 1240.

The Y-axis light detection pixel driving signal generating unit 530 includes a plurality of NOT elements 531 and a plurality of AND elements 532. One of the NOT elements 531 and one of the AND elements 532 form a pair so that m pairs are formed.

The NOT elements 531 receive a gap signal 444 output from the light detection pixel drive inter-gap generating unit 440 as an input signal. The output of each of the NOT elements 531 is connected to one of the two inputs of the corresponding one of the AND elements 532. The other input of the AND element 532 receives the corresponding one of the signals L_D_y0 to L_D_ym output from the D flip-flop unit 521. Outputs of the m AND elements 532 are output to the m Y-axis light detection pixel control lines 147.

The light detection pixel X-axis output signal line selecting unit 540 includes m switching elements (the Y-axis output selecting transistors) 146. The gates of the m switching elements are connected to the m Y-axis light detection pixel control lines 147 (147-1, 147-2, . . . 147-m) One end of each of the switching elements 146 is connected to one of the light detection pixel X-axis output signal lines 143-1 to 143-m of the image display unit 1 (see FIGS. 3 and 4). The other end of each of the switching elements 146 is connected to the light detection pixel output signal line 148 of the image display unit 1.

### Configuration of Light Emitting Unit

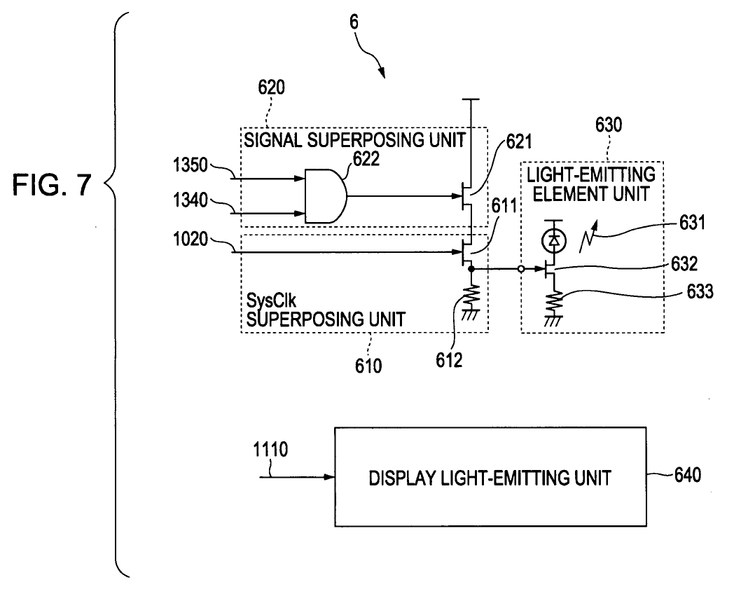

FIG. 7 illustrates an exemplary configuration of the light emitting unit 6 according to the present embodiment.

As shown in FIG. 7, the light emitting unit 6 includes a carrier (SysClk) superposing unit 610, a signal superposing unit 620, a light-emitting element unit 630, and a display light emitting unit 640. Note that, in FIG. 7, the carrier superposing unit 610, the signal superposing unit 620, the light-emitting element unit 630 are composed of N-type FETs. However, the functions of the carrier superposing unit 610, the signal superposing unit 620, and the light-emitting element unit 630 may be realized by any other methods.

In the carrier superposing unit 610, a source follower transistor is used as a transistor 611. The clock SysClk 1020 output from the clock generation unit 10 is input to the gate of the transistor 611. The source of the transistor 611 is connected to a ground potential GND via a resistor 612. The drain of the transistor 611 is connected to the source of a transistor 621 of the signal superposing unit 620.

The signal superposing unit 620 includes the transistor 621 and an AND element 622. The output of the AND element 622 is input to the base of the transistor 621. The drain of the transistor 621 is connected to a power supply.

The inputs of the AND element 622 are connected to lines that supply signals LED_En 1350 and LED_Sig 1340 output from the light emission control unit 13.

The light-emitting element unit 630 includes an LED 631, a transistor 632, and a resistor 633. The anode of the LED 631 is connected to a power supply. The cathode of the LED 631 is connected to the drain of the transistor 632. The base of the transistor 632 is connected to a source follower output of the transistor 611. The source of the transistor 632 is connected to the ground potential GND via the source resistor 633.

The light-emitting element unit 630 may include a plurality of the LEDs 631, and a plurality of the light-emitting element units 630, each including the plurality of the LED 631, may be used as necessary. When a light-emitting element, such as an organic EL, is used as the light-emitting element unit 630, the light-emitting element itself may serve as the light-emitting element unit 630.

Light emission performed by the display light emitting unit 640 is controlled by a display light emission control signal 1110 output from the display information control unit 11.

### Configuration of Clock Generation Unit

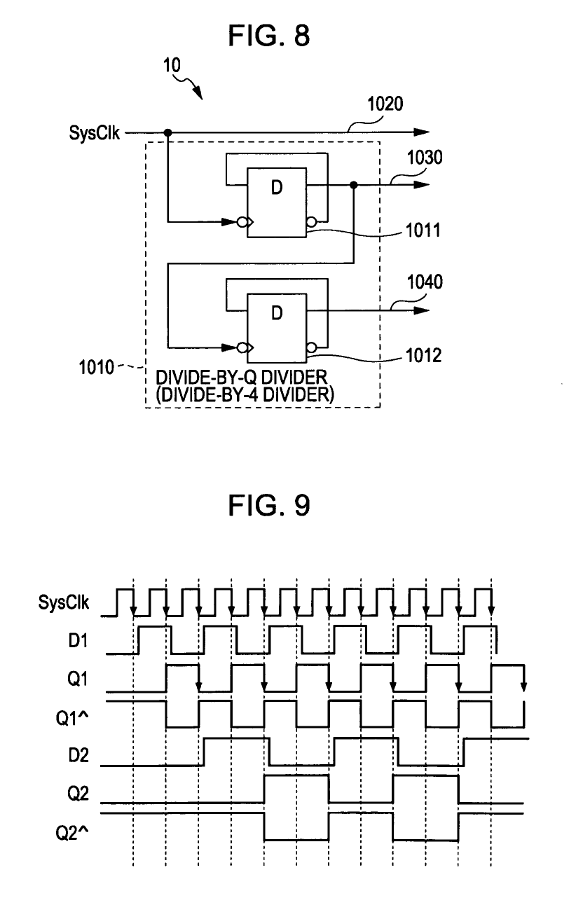

FIG. 8 illustrates an exemplary configuration of the clock generation unit 10 according to the present embodiment. FIG. 9 is a timing diagram of the clock generation unit 10 shown in FIG. 8.

As shown in FIG. 8, the clock generation unit 10 includes a divide-by-Q divider 1010 that divides the clock SysClk 1020 by Q. Since the clock SysClk 1020 also serves as a carrier signal, a frequency (e.g., a frequency of about 100 to about 200 kHz) that is higher than that generated by inverter lighting equipment is used for the clock SysClk 1020.

In FIGS. 8 and 9, the clock SysClk 1020 is divided by 4 as an example. This is because a cycle that is more than or equal to twice a cycle obtained by summing a cycle of the clock SysClk 1020 and a pulse width of the gap signal 444 generated by the light detection pixel drive inter-gap generating unit 440 of the X-axis light detection pixel drive unit 4 is necessary for the clock. More specifically, a cycle that is more than or equal to twice the cycle obtained by summing a cycle of the system clock SysClk 1020 and a pulse width of the gap signal 444 is necessary for a clock of the coordinate bit number generating unit 1210 of the light detection pixel drive control unit 12.

By satisfying this condition, the touch signal generated by the signal processing unit 8 can be restored as for the signal LED_Sig 1340 generated by the light emission control unit 13. In this example, the gap signal 444 is generated so that one pulse of the gap signal 444 is equal to one cycle of the system clock SysClk 1020. Accordingly, a clock 2SysClk 1030 having a cycle twice that of the system clock SysClk 1020 is generated, and the clock 4SysClk 1040 having a cycle twice that of the system clock 2SysClk 1030 (having a cycle four times that of the system clock SysClk 1020) is generated.

The divide-by-Q (4) divider 1010 includes a D flip-flop 1011 and a D flip-flop 1012.

The D flip-flop 1011 uses the clock SysClk 1020 as an input clock. The D flip-flop 1011 generates the clock 2SysClk 1030 having a cycle twice that of the clock SysClk. An inverted output of the clock 2SysClk 1030 is input to the D flip-flop 1011.

The D flip-flop 1012 uses the clock 2SysClk 1030 as an input clock. The D flip-flop 1012 generates the clock 4SysClk 1040 having a cycle twice that of the clock 2SysClk 1030 (i.e. a cycle four times that of the clock SysClk 1020). An inverted output of the clock 4SysClk 1040 is input to the D flip-flop 1012.

While the above example has been described with reference to the divide-by-4 divider, any divider can be used if a cycle that is greater than or equal to the sum of one cycle of the clock SysClk 1020 and one pulse width of the gap signal 444 is generated.

### Configuration of Signal Processing Unit

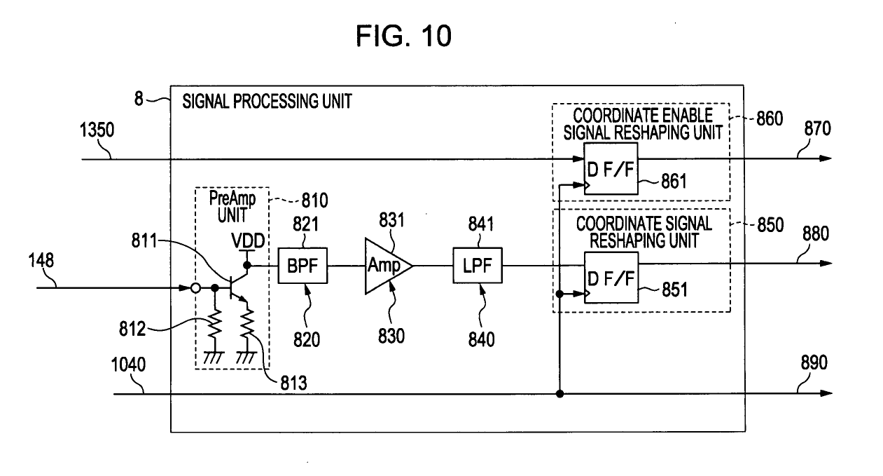

FIG. 10 illustrates an exemplary configuration of the signal processing unit 8 according to the present embodiment.

As shown in FIG. 10, the signal processing unit 8 includes a pre-amplifier (PreAmp) unit 810, a SysClk signal extracting unit 820, a SysClk signal amplifier unit 830, a SysClk signal removal unit 840, a coordinate signal reshaping unit 850, and a coordinate enable signal reshaping unit 860.

The PreAmp unit 810 performs current-to-voltage conversion of a signal output from the light detection pixel output signal line 148. FIG. 10 illustrates an example of current-to-voltage conversion and amplification performed by the PreAmp unit 810 using an npn transistor 811.

The transistor 811 has the emitter grounded through a resistor 813. A bias resistor 812 is connected to the base of the transistor 811. The transistor 811 converts an electrical current output from the light detection pixel output signal line 148 to a voltage, which is output to the collector of the transistor 811. The collector of the transistor 811 is connected to a power supply.

The SysClk signal extracting unit 820 receives the voltage signal output from the collector of the transistor 811 and extracts a SysClk clock signal. Accordingly, the SysClk signal extracting unit 820 includes a bandpass filter (BPF) 821 that allows only the SysClk signal to pass therethrough.

The SysClk signal amplifier unit 830 includes an amplifier (Amp) 831. The SysClk signal amplifier unit 830 receives the output of the BPF 821 and amplifies the output of the BPF 821 to a level that is recognizable by the coordinate signal reshaping unit 850.

The SysClk signal removal unit 840 includes a lowpass filter (LPF) 841. The SysClk signal removal unit 840 receives the output of the Amp 831 and removes a frequency component of the SysClk signal. In this way, the SysClk signal removal unit 840 allows a coordinate signal to pass therethrough.

The coordinate signal reshaping unit 850 includes a D flip-flop 851. The coordinate signal reshaping unit 850 receives the output of the LPF 841 and the clock 4SysClk 1040 output from the clock generation unit 10. The coordinate signal reshaping unit 850 outputs a touch signal 880 in synchronization with the clock 4SysClk 1040.

The coordinate enable signal reshaping unit 860 includes a D flip-flop 861. The coordinate enable signal reshaping unit 860 receives the signals LED_En 1350 output from the light emission control unit 13 and the clock 4SysClk 1040 as an input clock. The coordinate enable signal reshaping unit 860 outputs an enable signal Enable 870 in synchronization with the clock 4SysClk 1040. That is, the clock 4SysClk 1040 is used as a synchronization clock SClk 890 of the touch signal 880 and the enable signal Enable 870.

In the above description, exemplary configurations are illustrated. The important point is a step of converting an electrical current signal output from a light detection pixel to a voltage, retrieving the system clock SysClk from the signal, removing the system clock SysClk, and acquiring a coordinate signal.

Exemplary configurations and functions of the various units are determined as described above.

An exemplary operation for generating the light emission control signal, an exemplary operation performed by the light detection pixel drive unit, an exemplary operation performed by the signal processing unit 8 before the touch signal 880 is output are described below.

### Generation of LED_{SIG}

An exemplary operation of generating the signal LED_Sig performed by the light emission control unit 13 is described next.

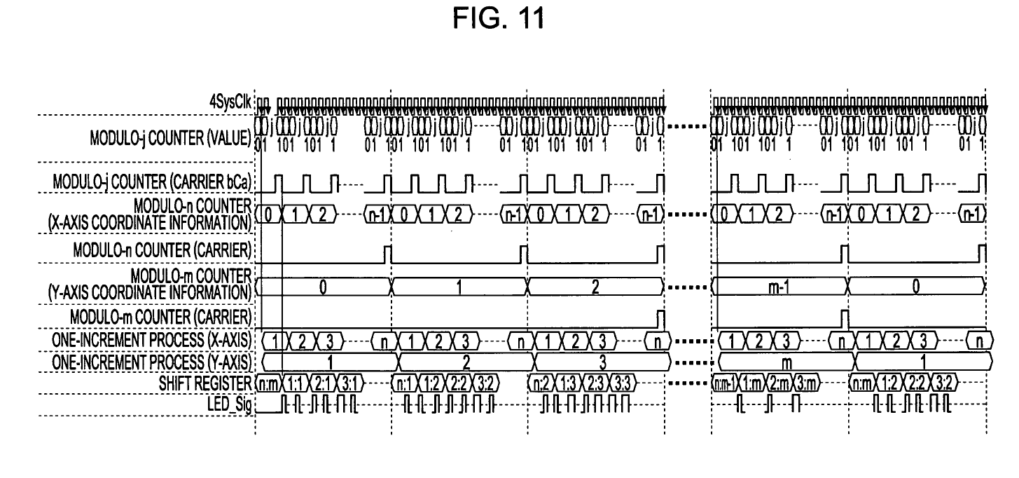

FIG. 11 is a timing diagram of the light emission control unit 13 when the light emission control unit 13 generates the signal LED_Sig.

In FIGS. 5 and 11, the modulo-j counter 1212 of the coordinate bit number generating unit 1210 receives the clock 4SysClk 1040 generated by the clock generation unit 10 and performs a counting-up operation up to j.

When j is counted, the modulo-j counter 1212 generates the carrier signal bCa 1240. As shown in FIG. 11, the modulo-j counter 1212 generates a pulse having a pulse width equal to one cycle of the clock 4SysClk 1040 from a low level (Low) to the high level (H).

The modulo-n counter 1222 of the X-coordinate generating unit 1220 receives the clock 4SysClk 1040 as a synchronization clock. The modulo-n counter 1222 further receives the carrier signal bCa 1240 from the modulo-j counter 1212 as an input signal and performs a counting-up operation. In this way, the modulo-n counter 1222 generates the Y-axis coordinate information 1260 and the carrier signal 1223.

The carrier signal 1223 is a pulse signal having a pulse width equal to one cycle of the clock 4SysClk 1040.

The modulo-m counter 1232 of the Y-coordinate generating unit 1230 receives the clock 4SysClk 1040 as a synchronization clock. The modulo-m counter 1232 further receives the carrier signal bCa 1240 from the modulo-j counter 1212 and the carrier signal 1223 from the modulo-n counter 1222 as input signals and performs a counting-up operation. In this way, the Y-coordinate generating unit 1230 generates the Y-axis coordinate information 1260 and the carrier signal 1233.

The carrier signal 1233 is a pulse signal having a pulse width equal to one cycle of the clock 4SysClk 1040.

The coordinate information conversion unit 1310 of the light emission control unit 13 increments the X-axis coordinate information 1250 and the Y-axis coordinate information 1260 by one. The coordinate information conversion unit 1310 operates in synchronization with the clock 4SysClk 1040 so as to generate the X value 1313 and the Y value 1314.

The shift register unit 1320 retrieves the X value 1313 into the lower bits thereof and the Y value 1314 into the higher bits thereof in synchronization with the fall of the carrier signal bCa 1240.

In addition, in synchronization with the clock 4SysClk 1040, the shift register unit 1320 sequentially delivers the X value 1313 from the 0th bit of the X value 1313 and the Y value 1314 as the LED_Sig 1340.

After delivering the current X value 1313 and the current Y value 1314, the shift register unit 1320 delivers the next X value 1313 and the next Y value 1314.

For example, as shown in FIG. 11, the X value 1313 of “1” and the Y value 1314 of “1” are delivered from the shift register unit 1320. Subsequently, the X value 1313 of “2” and the Y value 1314 of “1” are delivered from the shift register unit 1320. Thereafter, the X value 1313 of “3” and the Y value 1314 of “1” are delivered from the shift register unit 1320.

### Generation of LED_EN

An exemplary operation performed by the light emission control unit 13 for generating the signal LED_En is described next.

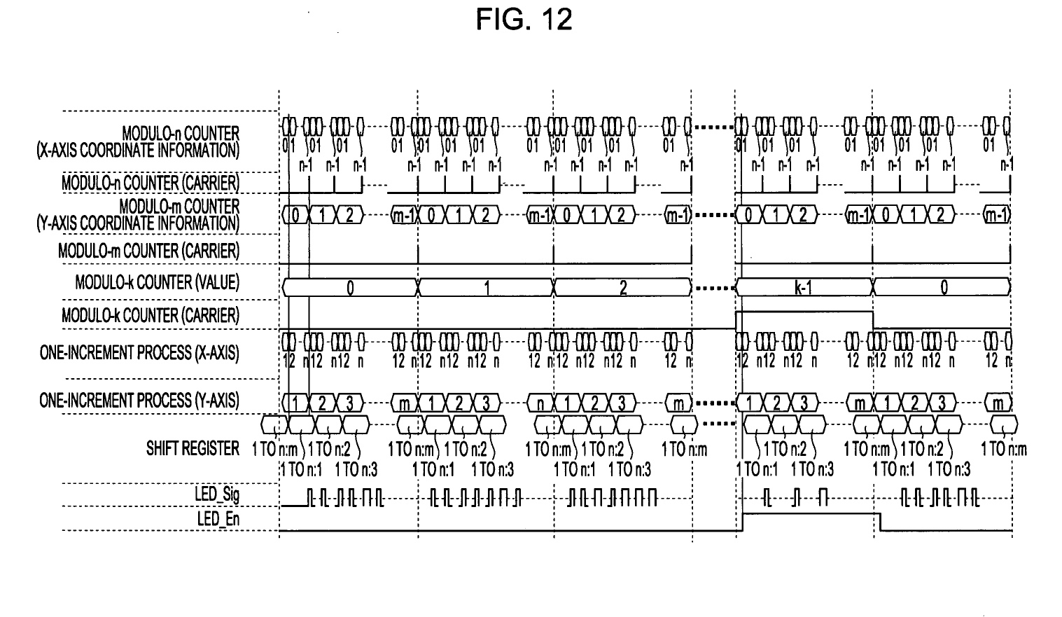

FIG. 12 is a timing diagram of LED_En signal generation performed by the light emission control unit 13.

As shown in FIGS. 5 and 12, the modulo-k counter 1332 of the intermittent signal generating unit 1330 receives the clock 4SysClk 1040 as a synchronization clock. The modulo-k counter 1332 further receives the carrier signal 1233 from the modulo-m counter 1232 as an input signal and performs a counting-up operation. In this way, the modulo-k counter 1332 generates the carrier signal 1333. The carrier signal 1333 has a high level (H) during a k-th count. The carrier signal 1333 is input to the D flip-flop 1334 in synchronization with the carrier signal bCa 1240. Thus, the signal LED_En 1350 is generated.

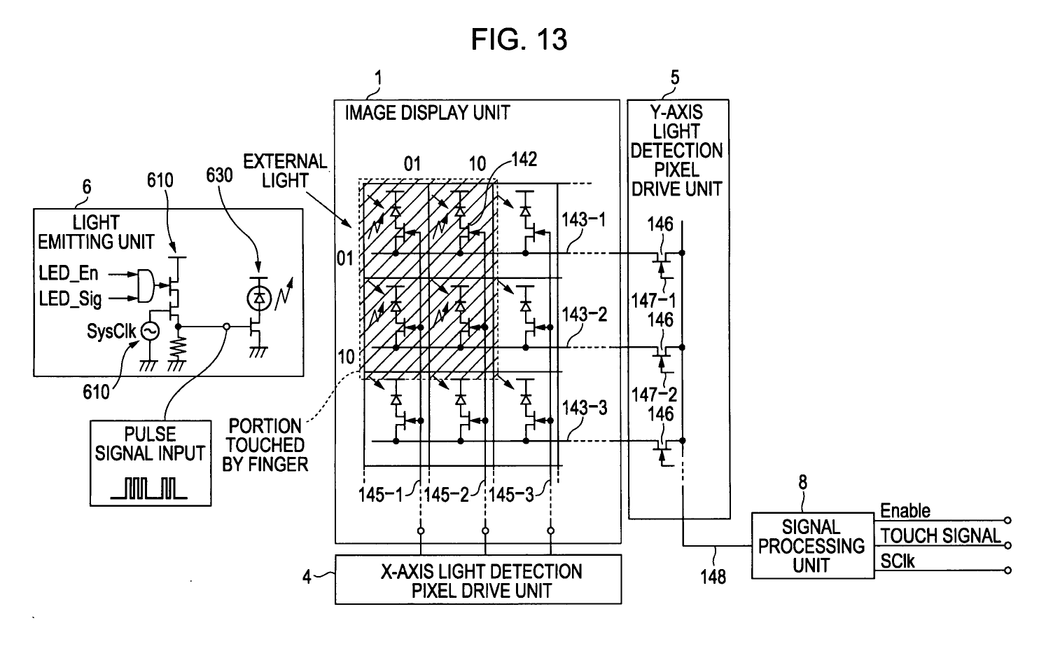

An exemplary operation for detecting a touching portion is described next. In this example, the case in which, as shown in FIG. 13, a finger touches four of the light detection pixels 140 of the image display unit 1 is described.

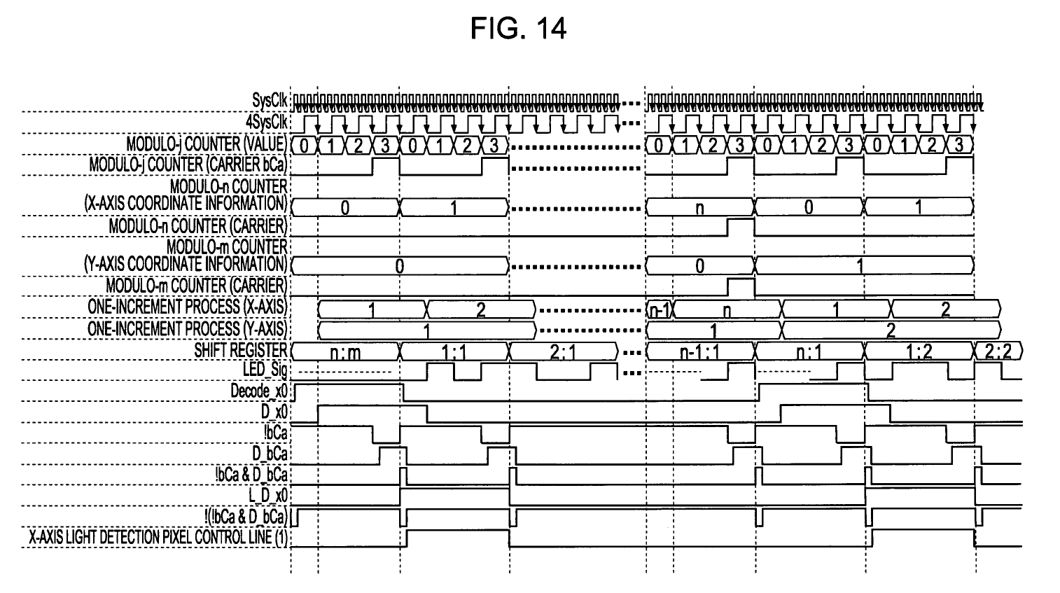

Exemplary operations performed by the X-axis light detection pixel drive unit 4 and the Y-axis light detection pixel drive unit 5 are described with reference to FIG. 14.

FIG. 14 is a timing diagram of the X-axis light detection pixel drive unit 4 for the 0th bit of the X value.

As shown in FIGS. 6, 13, and 14, when the X-axis coordinate information 1250 outputs the value “00”, the decoder 411 of the decoding unit 410 outputs the decoding result by setting the signal line Decode_x0 for the 0th bit to a high level (H).

Thereafter, since the D flip-flop unit 412 operates in synchronization with the clock 4SysClk 1040, the D flip-flop unit 412 generates the signal D_x0 that is synchronized with the clock 4SysClk 1040. The signal D_x0 is latched by the latch unit 420 in synchronization with the carrier signal bCa 1240. Thus, the signal L_D x0 is generated.

The light detection pixel drive inter-gap generating unit 440 generates, from the carrier signal bCa 1240, the gap signal 444 having a pulse width that is the same as one cycle of the clock 4SysClk 1040.

The X-axis light detection pixel driving signal generating unit 430 combines the signal L_D_x0 and the gap signal 444 so as to generate a signal to be input to the X-axis light detection pixel control line 145-1. A similar operation is performed for the other bits of the X axis and for the Y axis. Thus, signals input to the X-axis light detection pixel control lines 145 and the Y-axis light detection pixel control lines 147 are generated.

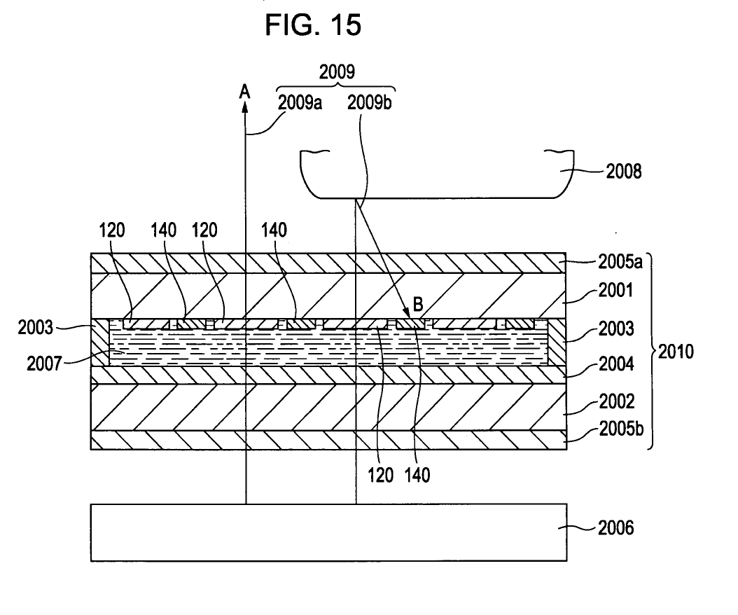

An exemplary configuration of the optical system of the display unit is described next. FIG. 15 illustrates an optical system of a flat display unit according to the present embodiment.

An array substrate 2001 includes the display pixels 120 and the light detection pixels 140 arranged in a matrix. A shield wall 2003 is supported between the array substrate 2001 and a counter substrate 2002. A counter electrode 2004 is formed on the counter substrate 2002. A polarizer sheet (a polarizer film) 2005a is disposed on the array substrate 2001. A polarizer sheet 2005b is disposed on the counter substrate 2002.

A fluorescent tube, a white LED, or an R (red)-G (green)-B (blue) LED can be used as a light source of a backlight 2006. Light is emitted from the display light emitting unit 640 shown in FIG. 7.

At the same time, light 2009 that serves as detection light is emitted from the light source of the light-emitting element unit 630 and is also output from the backlight 2006. The light 2009 output from the backlight 2006 is made incident on the counter substrate 2002. The light 2009 is modulated by a liquid crystal layer 2007. Subsequently, the light 2009 is output from the array substrate 2001.

If an object 2008, such as a finger, is disposed over the array substrate 2001, the light 2009 that passes through a space where the object 2008 is not present travels straight in the form of light 2009a. However, the light 2009 that hits the object 2008 is reflected by the object 2008 in the form of light 2009b. The light 2009b is made incident on one of the light detection pixels 140 located at a position B. In the light detection pixel 140 that receives the light 2009b, the electrical charge leaks in accordance with the intensity and exposure time of the light 2009b.

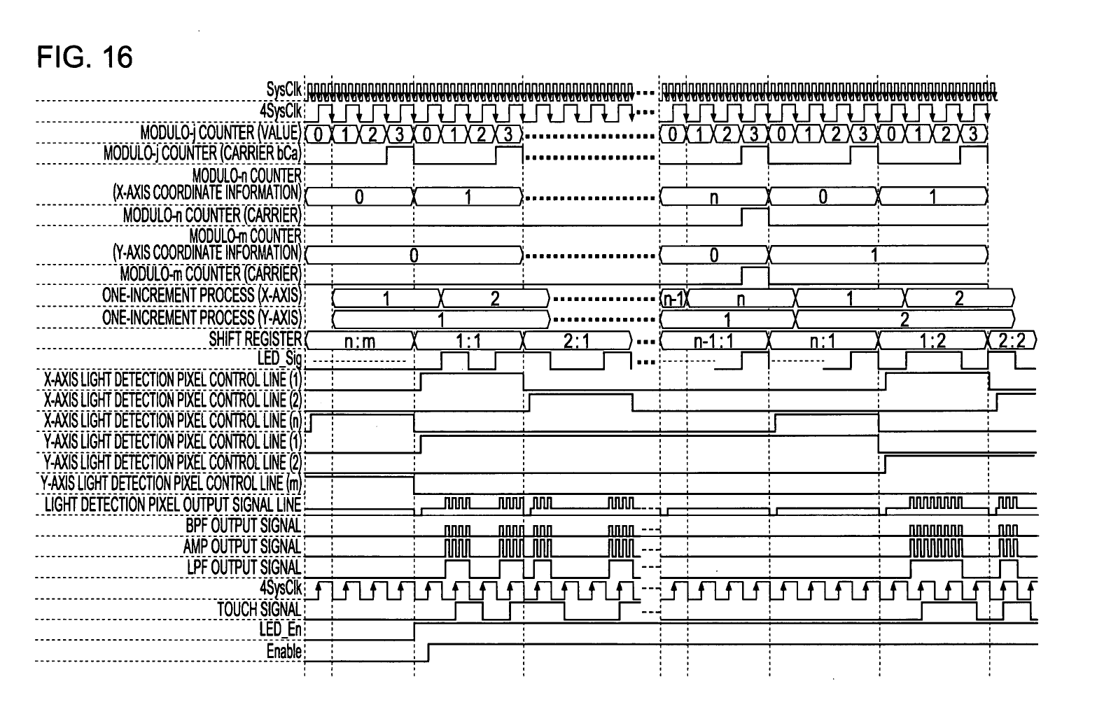

An exemplary operation performed by the signal processing unit 8 in order to output the touch signal 880 is described next with reference to FIG. 16. FIG. 16 is a timing diagram of when the touch signal 880 is output from the signal processing unit 8.

As shown in FIGS. 10, 13, 15, and 16, the signal LED_Sig 1340 is output from the light-emitting element unit 630 of the light emitting unit 6 only when the signals LED En 1350 is at a high level (H). At that time, the light-emitting element unit 630 superposes the system clock SysClk 1020 on the signal LED_Sig 1340, and the light is emitted.

If, as shown in FIG. 13, the light detection pixels 140 located at the X-Y coordinates (1, 1), (2, 1), (1, 2), and (2, 2) are covered by a finger, the light emitted from the light-emitting element unit 630 is reflected by the finger and is received by the light detection pixels 140.

The light received by the light detection pixels 140 is converted into an electrical current value or a voltage value. The converted electrical current value or voltage value is transferred to the light detection pixel X-axis output signal line 143 when the X-axis light detection pixel control line 145 of the X-axis light detection pixel drive unit 4 has a high level (H) at a desired timing and, therefore, the X-axis output selecting transistor 142 is turned on.

Similarly, the Y-axis light detection pixel control line 147 has a high level (H) at a desired timing and, therefore, the Y-axis output selecting transistor 146 is turned on. Accordingly, a signal current or a signal voltage of the light detection pixel X-axis output signal line 143 is transferred to the light detection pixel output signal line 148.

For example, when a signal (0101) is emitted at the coordinates (1, 1), the X-axis light detection pixel control line 145-1 has a high level (H), and the Y-axis light detection pixel control line 147-1 has a high level (H). The light-emitting element unit 630 emits light in accordance with the signal (0101) superposed with the system clock SysClk 1020. The emitted light is reflected by, for example, a finger. Accordingly, a signal generated at that time appears in the light detection pixel output signal line 148.

Similarly, when a signal (1001) is emitted at the coordinates (2, 1), the X-axis light detection pixel control line 145-2 has a high level (H), and the Y-axis light detection pixel control line 147-1 has a high level (H). The light-emitting element unit 630 emits light in accordance with the signal (1001) superposed with the system clock SysClk 1020. The emitted light is reflected by, for example, a finger. Accordingly, a signal generated at that time appears in the light detection pixel output signal line 148.

When the signal of the light detection pixel output signal line 148 is in the form of an electrical current, the signal is converted to a voltage signal. The signal is then amplified and output by the PreAmp unit 810 of the signal processing unit 8.

In order to detect the clock SysClk 1020 from the signal output from the PreAmp unit 810, the BPF 821 extracts the clock SysClk 1020. The Amp 831 amplifies the signal of the clock SysClk 1020 extracted by the BPF 821 to a level that can be detected by the coordinate signal reshaping unit 850.

In order to remove the clock SysClk 1020 from the signal output from the Amp 831, the LPF 841 is applied to the signal. By removing the clock SysClk 1020 using the LPF 841, the coordinate information (0101) and (1001) can be retrieved.

By holding the signal output from the LPF 841 in synchronization with the clock 4SysClk 1040, the coordinate signal reshaping unit 850 can generate the touch signal 880.

### Second Exemplary Embodiment

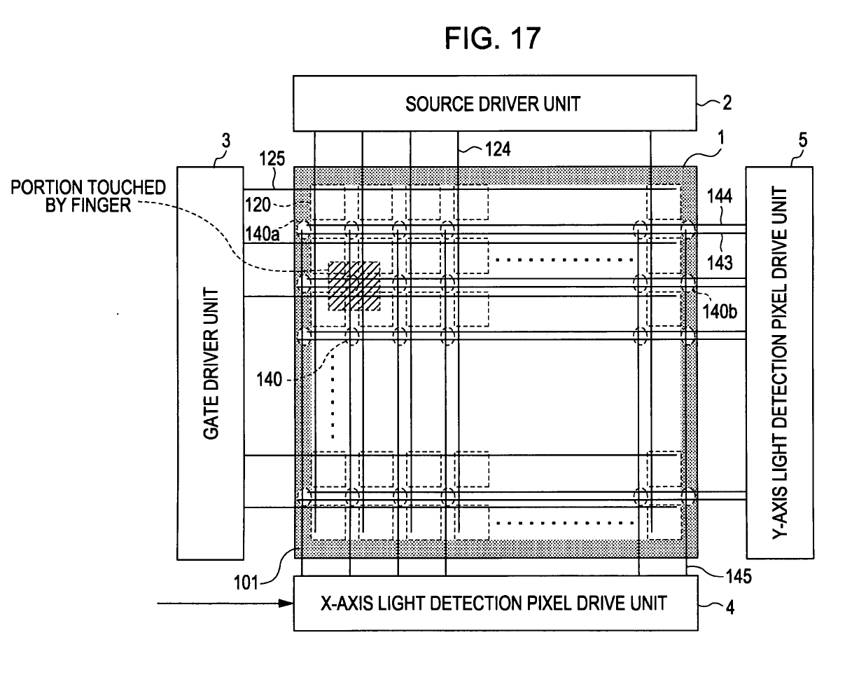

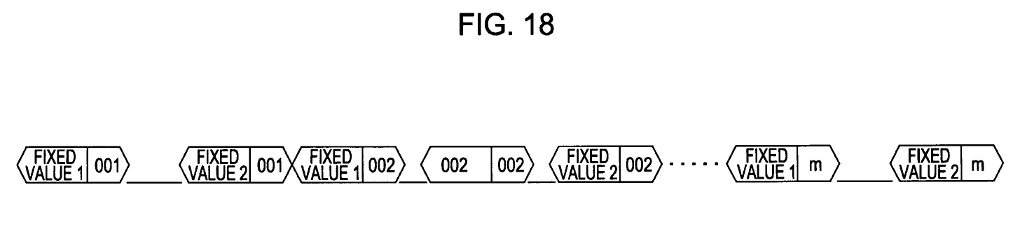

An image display apparatus according to a second exemplary embodiment of the present invention is described next. FIG. 17 illustrates the image display apparatus according to the second exemplary embodiment of the present invention. FIG. 18 is a diagram illustrating an example of a touch signal detected in the second exemplary embodiment.

Unlike the first exemplary embodiment, in the second exemplary embodiment, a light detection pixel 140a (a start unit) and a light detection pixel 140b (an end unit) are additionally provided to a black matrix portion 101, which is a peripheral portion of the image display unit 1.

By additionally providing the start light detection pixel 140a and the end light detection pixel 140b in the Y-axis direction, the Y-axis signals can be reliably detected.

Since the start light detection pixel 140a and the end light detection pixel 140b are disposed directly beneath the black matrix portion 101, the light emitted from the light-emitting element unit 630 is reflected at all times. Accordingly, the coordinate information conversion unit 1310 of the light emission control unit 13 provides specific values 1 and 2 to a signal added to the X value 1313.

In addition, the modulo-n counter 1222 is replaced with a modulo-(n+2) counter, and the one-increment process from the one-increment processing unit 1311 is skipped.

In FIG. 17, since a finger touches the portion at the coordinate (2, 2), the touch signal shown in FIG. 18 includes a signal at the coordinate (2, 2) in addition to a signal of the start light detection pixel 140a and a signal of the end light detection pixel 140b in the Y-axis direction.

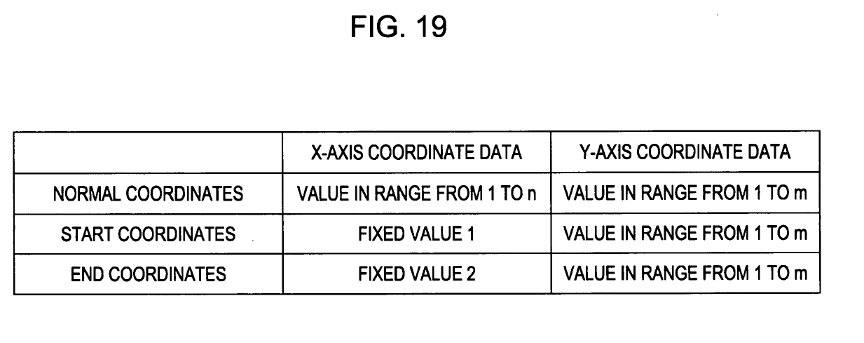

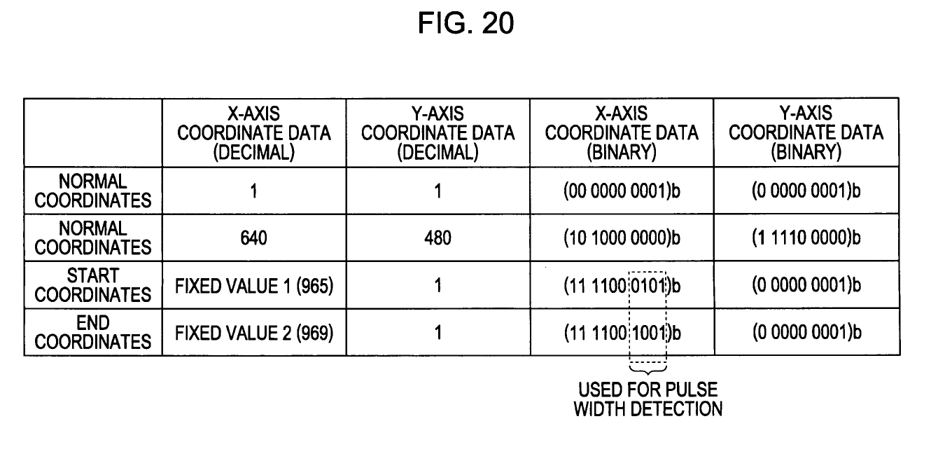

FIG. 19 illustrates a pattern of a value of a general light emission signal LED_Sig and a value output as a touch signal. FIG. 20 illustrates a particular example of a value of a light emission signal LED_Sig and a value output as a touch signal when the number of the X-axis light detection pixels is 640 and the number of the Y-axis light detection pixels is 480.

In this example, the specific value 1 is 965, and the specific value 2 is 969. The X-axis coordinate is represented using 10 bits, and the Y-axis coordinate is represented using 9 bits. The specific value 1 and the specific value 2 are binary values. That is, the specific value 1=965=1111000101b, and the specific value 2=969=1111001001b.

By using 0101b or 1010b for the lower 4 bits, signal processing using a pulse width ratio can be also performed.

In addition, by using bit strings that are not symmetrical for the start light detection pixel 140a and the end light detection pixel 140b, the start light detection pixel 140a and the end light detection pixel 140b can be reliably recognized.

By using the specific value 1 for the X-axis coordinate data of the start light detection pixel 140a, using the specific value 2 for the X-axis coordinate data of the end light detection pixel 140b, and directly using a Y value for the Y-axis coordinate data, the start light detection pixel 140a and the end light detection pixel 140b in accordance with a Y-axis value can be output from the touch signal.

In this case, if a portion at the coordinates (1, 1) is touched, [1, 1] is output from the light-emitting element unit 630 by the light emission signal LED Sig. Accordingly, serial data [1, 1] or [0000000001b, 000000001b] can be detected as a touch signal between the start light detection pixel 140a and the end light detection pixel 140b.

### Third Exemplary Embodiment

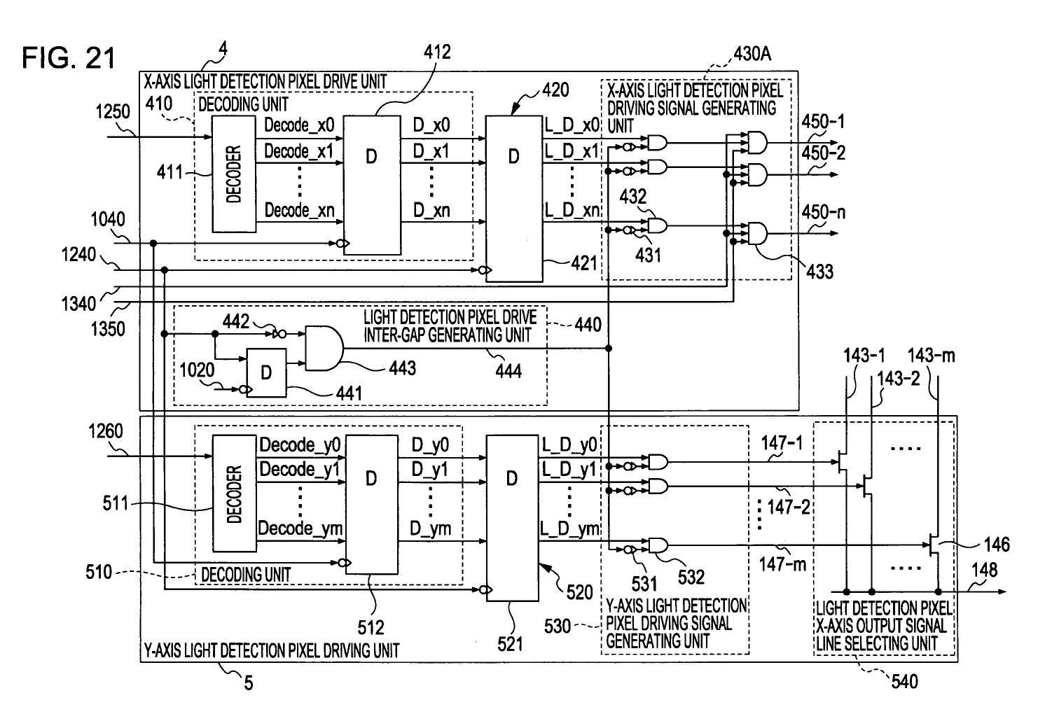

An image display apparatus according to a third exemplary embodiment of the present invention is described next. FIG. 21 illustrates exemplary configurations of an X-axis light detection pixel drive unit 4A and a Y-axis light detection pixel drive unit 5 of the image display apparatus according to the third exemplary embodiment.

As shown in FIG. 21, the configuration of an X-axis light detection pixel driving signal generating unit 430A of the X-axis light detection pixel drive unit 4A is different from that of the X-axis light detection pixel driving signal generating unit 430 shown in FIG. 6.

In FIG. 21, a signal LED_Sig 1340 for light emission and a signal LED_En 1350 for enabling light emission are input to two inputs of each of three-input AND elements 433 of the X-axis light detection pixel driving signal generating unit 430A of the X-axis light detection pixel drive unit 4A. The remaining one input of the AND element 433 is connected to the output of the AND elements 432. The output of each of the AND elements 433 is connected to a corresponding one of the X-axis light detection pixel control lines 450-1 to 450-n.

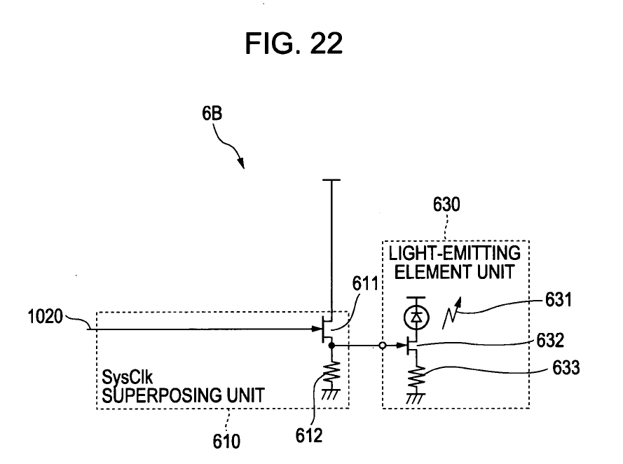

FIG. 22 illustrates an exemplary configuration of a light emitting unit 6B according to the third exemplary embodiment.

In the third embodiment, the light emitting unit 6B is a light pen (a lighting device for direct illumination), not a backlight. Accordingly, as shown in FIG. 22, the light emitting unit 6B has no signal superposing unit 620 of the light emitting unit 6 shown in FIG. 7.

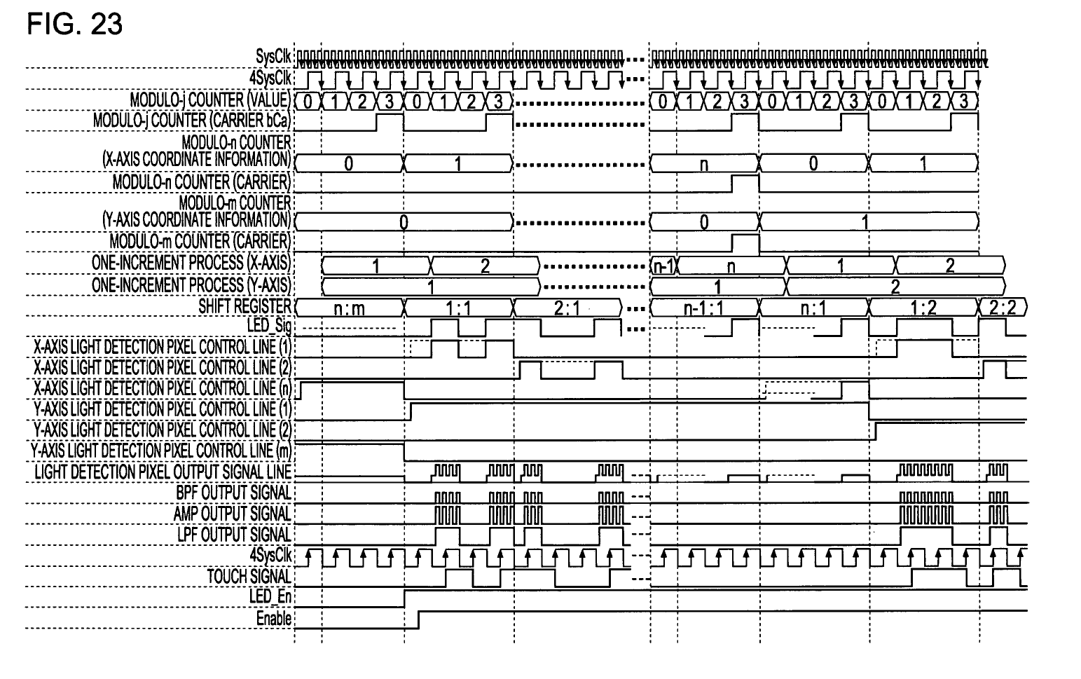

FIG. 23 is a timing diagram of when light is emitted from the light pen onto the area that is touched by a finger in FIG. 13.

In FIG. 23, a signal output to the X-axis light detection pixel control lines 450 can be obtained as a logical conjugation of the signal LED_Sig and the signal LED_En. Accordingly, the signal behaves as shown by the X-axis light detection pixel control line (1) without maintaining a high level (H) during a one-pixel period.

Thus, although the X-axis output selecting transistor 142 should be in an ON state during a selected period, the X-axis output selecting transistor 142 performs an ON and OFF switching operation in accordance with the signal LED_Sig and the signal LED_En.

Since the electrical current or voltage output from the light detecting element 141 is transferred or not transferred to the signal processing unit 8 due to the ON/OFF operation of the X-axis output selecting transistor 142, the signal as shown in FIG. 23 is transferred to the light detection pixel output signal line.

However, in the signal processing unit 8, the sysClk signal extracting unit 820 extracts only the clock SysClk 1020. Accordingly, the subsequent waveforms are the same as those of FIG. 16 and, therefore, the coordinate signal can be acquired in the form of a touch signal.

### Fourth Exemplary Embodiment

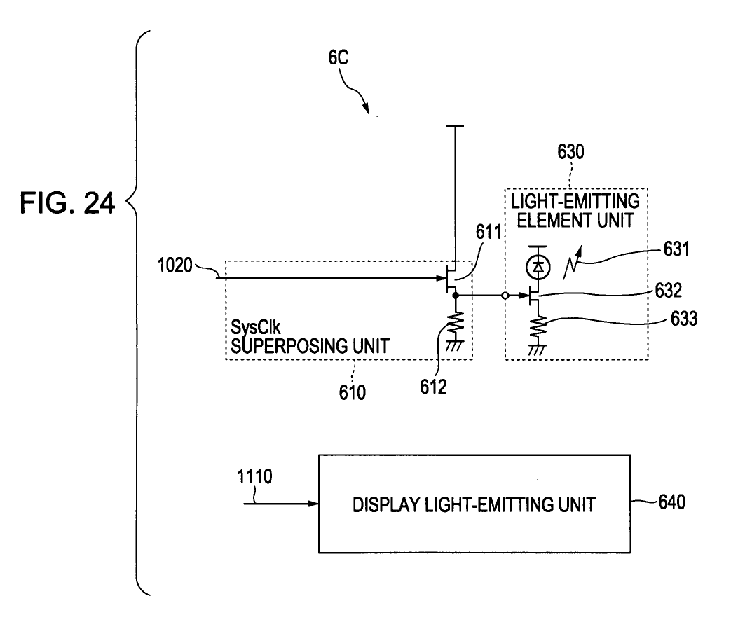

An image display apparatus according to a fourth exemplary embodiment of the present invention is described next. According to the fourth exemplary embodiment, an X-axis light detection pixel drive unit 4A has a circuit configuration that is the same as that of FIG. 21. FIG. 24 is a diagram illustrating an exemplary configuration of a light emitting unit 6C according to the fourth exemplary embodiment.

The light emitting unit 6C inputs light emitted from a light pen serving as the light emitting unit 6B shown in FIG. 22 and a clock SysClka 1020a having a frequency different from that of the clock SysClk 1020 to the base of the transistor 611, as shown in FIG. 23.

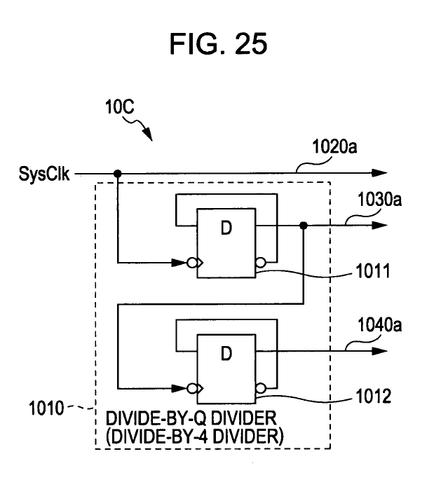

FIG. 25 is a diagram illustrating an exemplary configuration of a clock generation unit 10C that generates a clock used by the light emitting unit 6C according to the fourth exemplary embodiment.

The clock generation unit 10C has a configuration similar to that of the clock generation unit 10 shown in FIG. 8. The clock generation unit 10C generates a clock 4SysClka 1040a by dividing the clock SysClka 1020a having a frequency different from that of the clock SysClk 1020 by a factor of four.

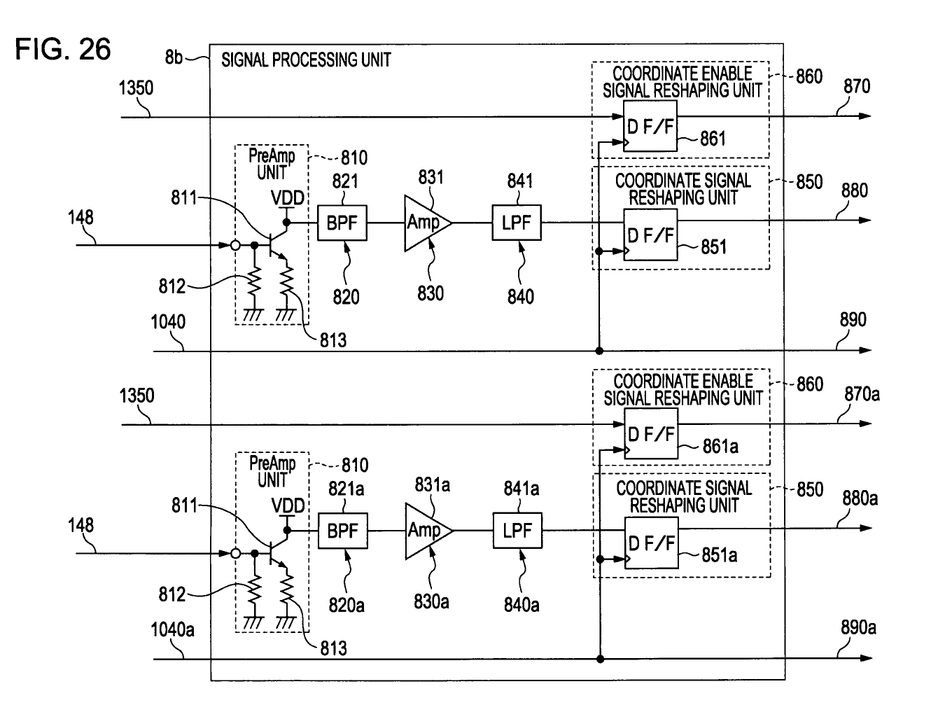

FIG. 26 is a diagram illustrating an exemplary configuration of a signal processing unit 8C according to the fourth exemplary embodiment.

The signal processing unit 8C shown in FIG. 26 is configured as a system that operates using two types of clock: the clock SysClk 1020 and the clock SysClka 1020a.

After the electrical current signal of the light detection pixel output signal line 148 is converted into a voltage signal and is amplified by the PreAmp unit 810, the signal is passed through the SysClk signal extracting unit 820 and a SysClk signal extracting unit 820a. In this way, the clock SysClk 1020 and the clock SysClka 1020a can be retrieved. Thereafter, the clock SysClk 1020 and the clock SysClka 1020a are removed by the downstream SysClk signal removal unit 840 and SysClk signal removal unit 840a, respectively. In this way, the coordinate signal information can be acquired.

The downstream D flip-flops 861 and 851 operate in synchronization with the clock 4SysClk 1040, and downstream D flip-flops 861a and 851a operate in synchronization with the clock 4SysClka 1040a.

In the above-described manner, the input of the coordinate input with the light pen and the input of the coordinate input with the finger can be obtained at the same time.

Note that, in FIG. 25, the SysClk signal extracting unit 820a is formed by a BPF 821a, and the SysClk signal removal unit 840a is formed by an LPF 841a.

### Fifth Exemplary Embodiment

A digital camera including one of the image display apparatus according to the first to fourth exemplary embodiments is described next as a fifth exemplary embodiment.

FIG. 27 is a block diagram illustrating an exemplary configuration of a digital camera according to the fifth embodiment of the present invention.

As shown in FIG. 27, a digital camera 10000 includes a lens 10100, an imager 10200, a camera signal processing unit 10300, a camera drive control unit 10400, a signal processing unit 10500, an external terminal 10600, an electronic viewfinder (EVF) 10700, and a display unit 10800 according to one of the above-described exemplary embodiments.

The digital camera 10000 further includes a recording medium 10900, an encoding/decoding processing unit 11000, a recording medium control unit 11100, a mechanism drive control unit 11200, a microphone 11300, an audio signal processing unit 11400, and a speaker 11500.

Still furthermore, the digital camera 10000 includes a variety of operation keys 11600, a microcomputer 11700, an electronically erasable and programmable read only memory (EEPROM) 11800, a flash memory 11900, a synchronous dynamic random access memory (SDRAM) 12000, a power supply circuit 12100, a battery 12200, and an AC plug 12300.

An image is captured using the lens 10100 and the imager 10200. The captured image is then converted into image data by the camera signal processing unit 10300 that controls the camera drive control unit 10400.

The generated image data is displayed on an external monitor via the signal processing unit 10500 and the external terminal 10600, on the EVF 10700, or on the display unit 10800 according to one of the above-described exemplary embodiments.

In addition, the image data output from the signal processing unit 10500 is stored in the recording medium 10900 via the encoding/decoding processing unit 11000 and the recording medium control unit 11100.

When, for example, the recording medium 10900 is a DVD, the DVD is operated by the mechanism drive control unit 11200, the encoding/decoding processing unit 11000, and the recording medium control unit 11100. Thus, the image data is stored on the DVD.

Sound is captured by the microphone 11300 and is superposed on the image data via the audio signal processing unit 11400. Thereafter, the sound is output from a speaker of the external monitor via the external terminal 10600. The image data is stored in the recording medium 10900 via the encoding/decoding processing unit 11000 and the recording medium control unit 11100.

In addition, the sound is output from the internal speaker 11500 via the signal processing unit 10500 and the audio signal processing unit 11400.

The image data stored in the recording medium 10900 can be retrieved via the recording medium control unit 11100 and the encoding/decoding processing unit 11000. Thereafter, the image data can be displayed on the display unit 10800 or the EVF 10700 from the signal processing unit 10500. Alternatively, the image data can be displayed on the external monitor from the signal processing unit 10500 via the external terminal 10600.

The sound can be output from the speaker of the external monitor via the external terminal 10600 or from the internal speaker 11500 via the audio signal processing unit 11400.

A user can control the captured image, the data stored in the recording medium 10900, or the current date and time stored in the camera while monitoring the image displayed on the display unit 10800, the EVF 10700, or the screen of the monitor connected via the external terminal 10600.

Such control can be performed using the operation keys 11600 or the display unit 10800. Signals output from the operation keys 11600 or the display unit 10800 are processed by the microcomputer 11700. Instructions are delivered to the processing blocks. Thus, a variety of operations including a display operation are performed.

The EEPROM 11800 stores setting values for the digital camera. The flash memory 11900 stores a program to be executed by the microcomputer 11700. In addition, the flash memory 11900 is used as an internal memory.

The SDRAM 12000 is used as a buffer memory. The power supply circuit 12100, the battery 12200, and the AC plug 12300 serve as a power supply unit.

The light detection pixel drive control unit 12, the light emission control unit 13, and the clock generation unit 10 of the display unit according to one of the above-described exemplary embodiments can be realized by the microcomputer 11700.

When digital cameras display an image being captured or a captured image, the coordinate information is rarely acquired. In addition, erroneous operations may be performed by the user. Accordingly, at that time, the operation of the light-emitting element unit 630 of the light emitting unit 6 in the display unit 10800 is stopped. Since the microcomputer 11700 serves as the light emission control unit 13, this processing can be performed by setting the level of the signals LED_En 1350 to low (L).

One of the times when the coordinate information is acquired is a time when a menu is displayed. In such a case, the quality of an image is not important. Accordingly, in this case, the above-described light-emitting element that emits invisible light is not necessarily used. A light-emitting element that emits visible light, such as an organic EL element, can be used.

As described above, according to the exemplary embodiments of the present invention, the coordinate information can be acquired using widely used simplified signal processing using a luminance signal without interference by external light including light emitted from inverter light equipment. In addition, according to the exemplary embodiments of the present invention, a display unit that minimizes an increase in consumption power caused by an additionally provided light-emitting element can be realized. Furthermore, the display unit can detect whether the light is light emitted from a light pen or reflected light emitted from a backlight, and the display unit can output the two types of coordinate information at the same time.

Still furthermore, the thickness and the weight of an apparatus using the exemplary embodiments of the present invention can be reduced without decreasing the quality of an image, as compared with existing apparatuses including a touch panel.

Still furthermore, by providing a function of stopping the operation of the light emitting unit when the coordinate information is not necessary, the power consumption of a light emitting element can be reduced. In addition, erroneous operation performed by a user can be prevented.

Still furthermore, for apparatuses including one of the exemplary embodiments of the present invention, when the coordinate information is acquired, the quality of a displayed image may be low, in some cases. In such a case, a light source that emits invisible light is not necessary. For example, a light-emitting element that emits visible light (a white LED or an organic EL) can be used. When coordinate information is acquired and if the light-emitting element that emits visible light operates in the above-described manner according to one of the exemplary embodiments, an all-time-on lighting operation is changed to an intermittent lighting operation. Accordingly, the power consumption can be reduced. In addition, the light-emitting element can have long lifetime.

While the exemplary embodiments above have been described with reference to an active-matrix liquid crystal display device using a liquid crystal cell as a display element (an electro-optical element) of a display cell, the application is not limited to the liquid crystal display device. For example, the exemplary embodiments can be applied to a variety of display apparatuses, such as active-matrix EL display apparatuses that use an EL element as a display element of a pixel, plasma display apparatuses, and field emission displays (FEDs).

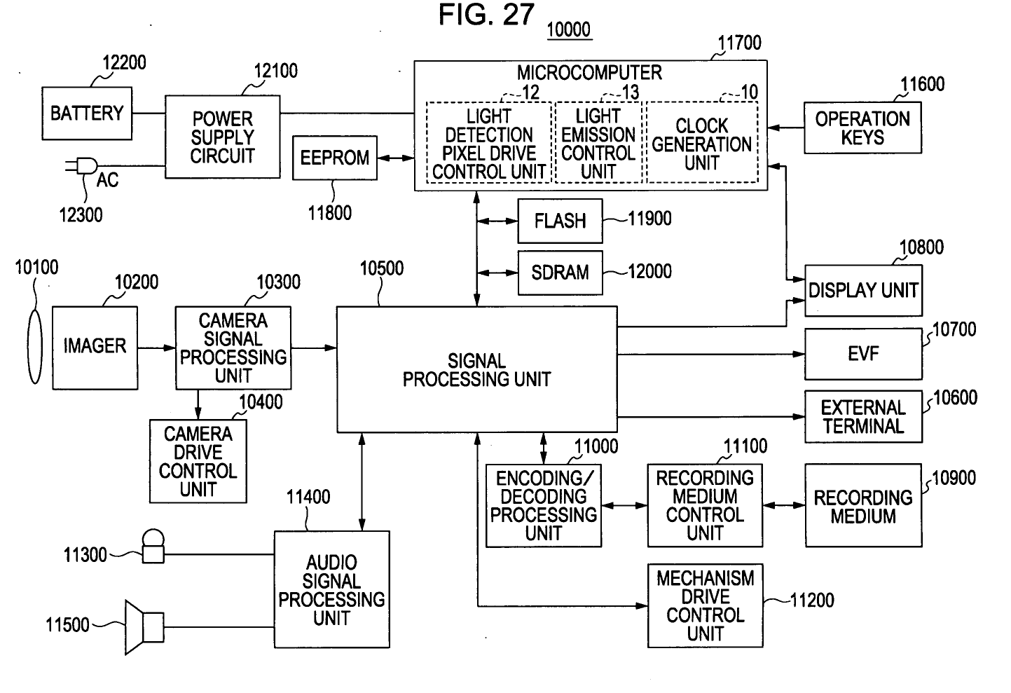

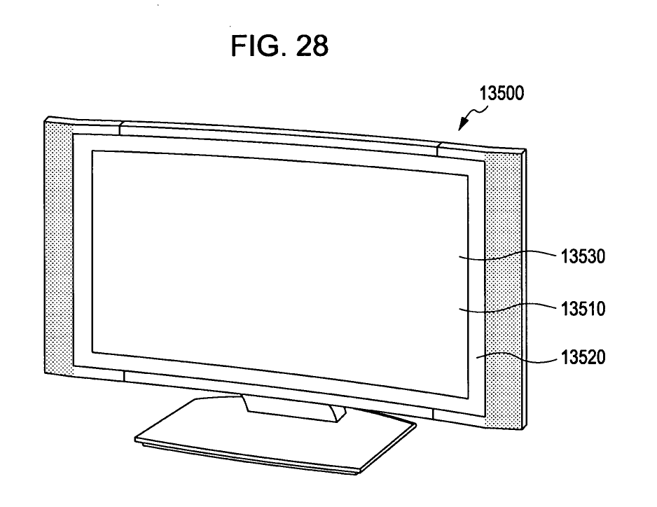

The display unit according to one of the above-described exemplary embodiments is applicable to a variety of electronic apparatuses shown in FIGS. 28 to 32. Examples of the electronic apparatuses include a digital camera, a laptop personal computer, a mobile terminal device, such as a cell phone, a desktop personal computer, and a video camera.

In addition, the display unit according to one of the above-described exemplary embodiments is applicable to a display unit of an electronic apparatus that displays an image signal input thereto or an image signal generated therein as a still image or a video image.

An example of the electronic apparatuses to which one of the above-described exemplary embodiments is applied is described next.

FIG. 28 is a perspective view of a television set to which one of the above-described exemplary embodiments is applied. A television set 13500 of this example includes a video display screen unit 13510. The video display screen unit 13510 includes a front panel 13520 and a filter glass 13530. The display unit according to one of the above-described exemplary embodiments is used as the video display screen unit 13510.

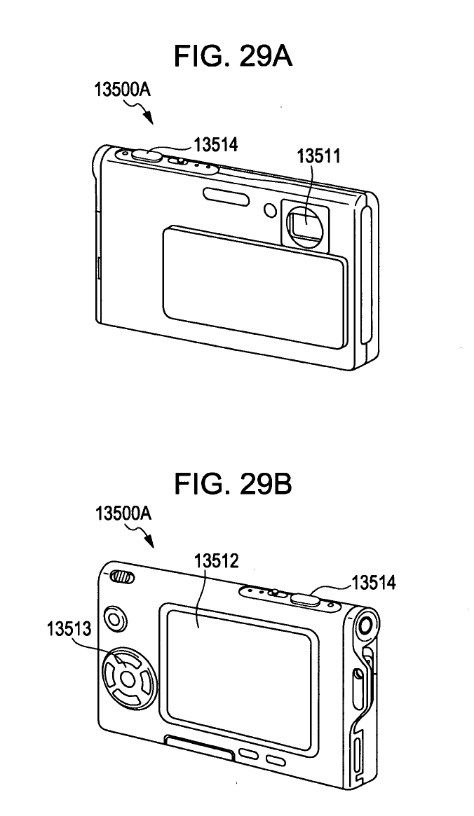

FIGS. 29A and 29B are perspective views of a digital camera to which one of the above-described exemplary embodiments is applied. FIG. 29A is a perspective view of the digital camera as viewed from the front side, while FIG. 29B is a perspective view of the digital camera as viewed from the back side

A digital camera 13500A of this example includes a flash 13511, a display unit 13512, a menu switch 13513, and a shutter button 13514. By using the display unit according to one of the above-described exemplary embodiments for the display unit 13512, the digital camera 13500A can be achieved.

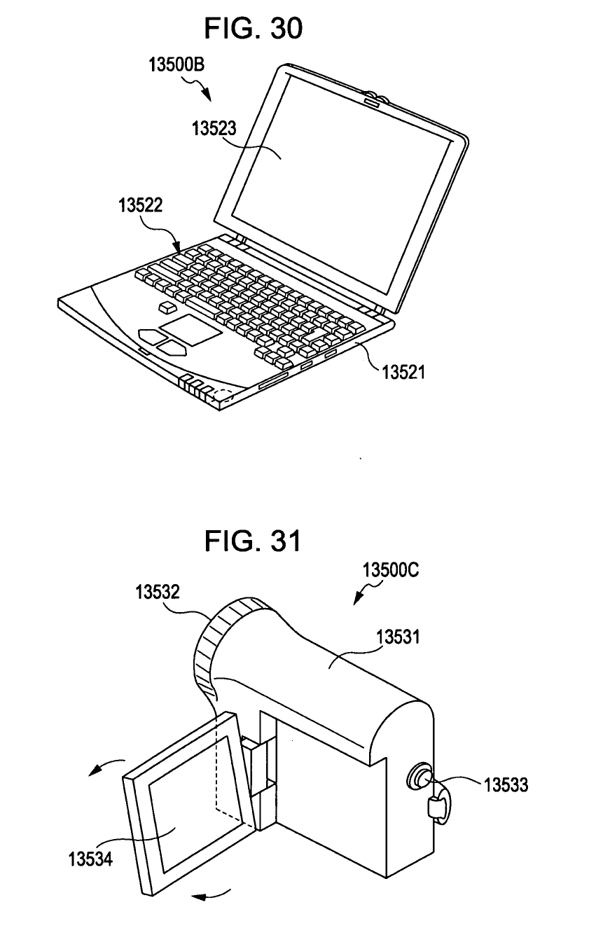

FIG. 30 is a perspective view of a laptop personal computer to which one of the above-described exemplary embodiments is applied.

A laptop personal computer 13500B of this example includes a main body 13521, a keyboard 13522 used when, for example, characters are input, and a display unit 13523. By using the display unit according to one of the above-described exemplary embodiments for the display unit 13523, the laptop personal computer 13500B can be achieved.

FIG. 31 is a perspective view of a video camera to which one of the above-described exemplary embodiments is applied.

A video camera 13500C of this example includes a main body 13531, a lens 13532 mounted on the front side for capturing an image of an object, an image-capturing start/stop switch 13533, and a display unit 13534. By using the display unit according to one of the above-described exemplary embodiments for the display unit 13534, the video camera 13500C can be achieved.

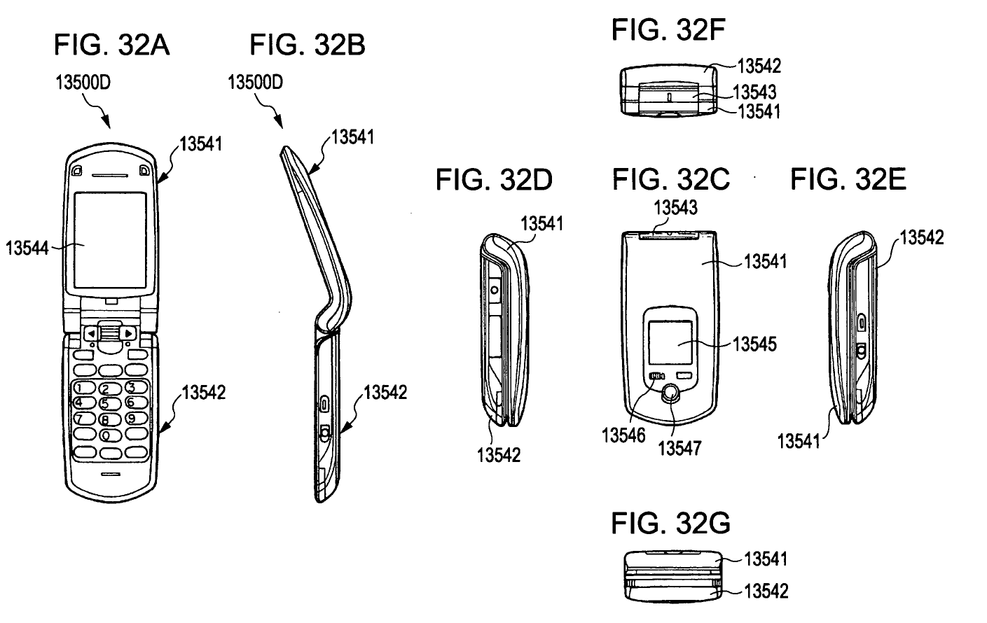

FIGS. 32A to 32G are diagrams illustrating a mobile terminal device (e.g., a cell phone) to which one of the above-described exemplary embodiments is applied. That is, FIG. 32A is a front view of the cell phone when the cell phone is open. FIG. 32B is a side view of the cell phone when the cell phone is open. FIG. 32C is a front view of the cell phone when the cell phone is closed. FIG. 32D is a left side view of the cell phone when the cell phone is closed. FIG. 32E is a right side view of the cell phone when the cell phone is closed. FIG. 32F is a top view of the cell phone when the cell phone is closed. FIG. 32G is a bottom view of the cell phone when the cell phone is closed.

A cell phone 13500D of this example includes an upper casing 13541, a lower casing 13542, a connection unit (a hinge in this example), a display unit 13544, a sub-display 13545, a picture light 13546, and a camera 13547. By using the display unit according to one of the above-described exemplary embodiments for the display unit 13544 and the sub-display 13545, the cell phone 13500D can be achieved.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display unit including a plurality of display elements and light detection elements;
a light emitting unit including a light emitting element that emits light in order to acquire coordinate information;
a first control unit configured to control the light emitting element of the light emitting unit;
a second control unit configured to selectively control driving of the plurality of light detection elements;
a signal processing unit configured to process a detection signal obtained by detecting light emitted from the light emitting unit using the light detection elements and acquire the coordinate information; and
a clock generation unit configured to provide a base frequency to the signal processing unit and the first and second control units;
wherein the first control unit causes the light emitting element of the light emitting unit to emit light during a signal light emission period and stop emission of the light during a light emission stop period, and wherein the first control unit superposes the base frequency on a signal serving as the coordinate information and causes the light emitting element of the light emitting unit to emit light during the signal light emission period.

2. The display apparatus according to claim 1, wherein the base frequency is a frequency other than a frequency generated by inverter lighting equipment.

3. The display apparatus according to claim 1 or 2, wherein the coordinate information is generated so as to exclude a bit pattern in which all the bits are “0”s or all the bits are “1”s.

4. The display apparatus according to any one of claims 1 to 3, wherein the second control unit selects one of the light detection elements in synchronization with the coordinate information contained in a signal emitted from the light emitting element of the light emitting unit.

5. The display apparatus according to any one of claims 1 to 4, wherein the signal processing unit extracts a component having the base frequency from the detection signal and acquires the coordinate information by removing the component having the base frequency from the detection signal.

6. The display apparatus according to any one of claims 1 to 5, wherein the second control unit selects one of the light detection elements by providing a gap period so that the signals output from the light detection elements are not superposed.

7. The display apparatus according to claim 6, wherein the second control unit generates the coordinate information using a cycle more than or equal to twice a sum of one cycle of the base frequency and the gap period.

8. The display apparatus according to any one of claims 1 to 7, wherein the light detection elements are disposed in a black matrix portion of the display unit, and the coordinate information is generated so as to indicate that detected reflection light is light from the black matrix portion when the reflection light from the black matrix portion is detected.

9. The display apparatus according to any one of claims 1 to 8, wherein the light emitting unit used for acquiring the coordinate information includes a light emitting element for direct illumination, and the first control unit that controls the light emitting element of the light emitting unit causes the light emitting element to emit light at the base frequency, and wherein the second control unit that selectively controls driving of the plurality of light detection elements selects one of the light detection elements to be driven in synchronization with the coordinate information contained in a signal emitted from the light emitting element during a signal detection period, stops the emission of light from the light emitting element during a light emission stop period, and operates in synchronization with a signal serving as the coordinate information.

10. The display apparatus according to claim 9, further comprising:
a backlight that emits display light onto the display unit;
wherein the display unit uses a plurality of basic frequencies and includes a plurality of signal processing units each corresponding to one of the basic frequencies, and wherein the display apparatus determines whether received light is reflection light from the backlight or transmission light from the light emitting element for direct illumination and operates in accordance with the determined type of the light.

11. The display apparatus according to any one of claims 1 to 10, wherein the display apparatus has a control function capable of stopping the operation of the light emitting unit used for acquiring the coordinate information when the operation of the light emitting unit used for acquiring the coordinate information is not necessary.

12. A method for driving a display apparatus, the display apparatus including a display unit including a plurality of display elements and light detection elements and a light emitting unit including a light emitting element for acquiring coordinate information, the display apparatus processing a detection signal obtained by using the light detection elements and detecting light emitted from the light emitting unit so as to acquire the coordinate information, the method comprising the step of:
causing the light emitting element of the light emitting unit to emit light during a signal light emission period and stop emission of the light during a light emission stop period;
wherein, during the signal light emission period, the base frequency is superposed on a signal serving as the coordinate information, and the light emitting element emits the light.

13. The method according to claim 12, wherein the base frequency is a frequency other than a frequency generated by inverter lighting equipment.

14. The method according to claim 12 or 13, wherein, when one of the light detection elements is selected, a gap period is provided so that the signals output from the light detection elements are not superposed, and wherein the coordinate information is generated by using a cycle more than or equal to twice a sum of one cycle of the base frequency and the gap period.

15. An electronic apparatus comprising:
a display apparatus, the display apparatus including a display unit including a plurality of display elements and light detection elements, a light emitting unit including a light emitting element that emits light in order to acquire coordinate information, a first control unit configured to control the light emitting element of the light emitting unit, a second control unit configured to selectively control driving of the plurality of light detection elements, a signal processing unit configured to process a detection signal obtained by detecting light emitted from the light emitting unit using the light detection elements and acquire the coordinate information, and a clock generation unit configured to provide a base frequency to the signal processing unit and the first and second control units;
wherein the first control unit causes the light emitting element of the light emitting unit to emit light during a signal light emission period and stop emission of the light during a light emission stop period, and wherein the first control unit superposes the base frequency on a signal serving as the coordinate information and causes the light emitting element of the light emitting unit to emit the light during the signal light emission period.
